(19) United States
(12) Patent Application Publication
(10) Pub. No.: US 2022/0229275 A1
(43) Pub. Date: Jul. 21, 2022

(54) Optical Imaging System

(71) Applicant: ZHEJIANG SUNNY OPTICS CO.,LTD., Ningbo, Zhejiang (CN)

(72) Inventors: Jianke WENREN, Ningbo, Zhejiang (CN); Xule KONG, Ningbo, Zhejiang (CN); Fujian DAI, Ningbo, Zhejiang (CN); Liefeng ZHAO, Ningbo, Zhejiang (CN)

(21) Appl. No.: 17/598,315

(22) PCT Filed: Sep. 24, 2020
(86) PCT No.: PCT/CN2020/117368

§ 371 Date: Sep. 27, 2021

(30) Foreign Application Priority Data
Oct. 8, 2019 (CN) 201910949230.5

(51) Int. Cl. G02B 13/00; G02B 9/64

(52) U.S. Cl. CPC G02B 13/0045; G02B 9/64

(57) ABSTRACT

The disclosure provides an optical imaging system, which sequentially includes from an object side to an image side along an optical axis: a first lens with a refractive power; a second lens with a refractive power, an image-side surface thereof is a concave surface; a third lens with a refractive power; a fourth lens with a refractive power; a fifth lens with a refractive power, an object-side surface thereof is a convex surface; a sixth lens with a refractive power; a seventh lens with a refractive power, an object-side surface thereof is a convex surface; and an eighth lens with a refractive power. Semi-FOV is a half of a maximum field of view of the optical imaging system, and Semi-FOV satisfies Semi-FOV<30°.

### CROSS-REFERENCE TO RELATED APPLICATION

The disclosure claims priority to and the benefit of Chinese Patent Present invention No. 201910949230.5, filed in the China National Intellectual Property Administration (CNIPA) on 8 Oct. 2019, entitled “Optical Imaging System”, the contents of which are hereby incorporated by reference in its entirety.

### TECHNICAL FIELD

The disclosure relates to the field of optical elements, and more particularly to an optical imaging system.

### BACKGROUND

In recent years, with the upgrading and updating of consumer electronic products and the development of image software functions and video software functions in consumer electronic products, market requirements on optical imaging systems applicable to portable electronic products have been gradually increased.

Due to the limit of a body size of a portable device, it is difficult to arrange a relatively large varifocal imaging system. Therefore, photographing of different focal lengths is usually implemented through a multi-lens group, usually including an optical imaging system with a telephoto end used as a varifocal imaging system.

For satisfying a miniaturization requirement and an imaging requirement, there is expected on the market an optical imaging system capable of considering miniaturization, great focal length and large aperture.

### SUMMARY

The disclosure provides an optical imaging system applicable to a portable electronic product and capable of at least overcoming or partially overcoming at least one shortcoming in related art.

The disclosure provides an optical imaging system, which sequentially includes from an object side to an image side along an optical axis: a first lens with a refractive power; a second lens with a refractive power, an image-side surface thereof may be a concave surface; a third lens with a refractive power; a fourth lens with a refractive power; a fifth lens with a refractive power; a sixth lens with a refractive power; a seventh lens with a refractive power, an object-side surface thereof may be a convex surface; and an eighth lens with a refractive power.

In an implementation mode, an image-side surface of the first lens may be a convex surface.

In an implementation mode, the second lens may have a negative refractive power.

In an implementation mode, an object-side surface of the fifth lens may be a convex surface.

In an implementation mode, Semi-FOV is a half of a maximum field of view of the optical imaging system, and Semi-FOV may satisfy Semi-FOV<30°.

In an implementation mode, the image-side surface of the first lens is a convex surface.

In an implementation mode, a total effective focal length f of the optical imaging system and an Entrance Pupil Diameter (EPD) of the optical imaging system may satisfy f/EPD≤1.3.

In an implementation mode, a maximum effective radius DT11 of an object-side surface of the first lens and a maximum effective radius DT81 of an object-side surface of the eighth lens may satisfy DT81/DT11≤0.87.

In an implementation mode, an on-axis distance SAG41 from an intersection point of an object-side surface of the fourth lens and the optical axis to an effective radius vertex of the object-side surface of the fourth lens and an on-axis distance SAG31 from an intersection point of an object-side surface of the third lens and the optical axis to an effective radius vertex of the object-side surface of the third lens may satisfy 0.1<SAG41/SAG31<0.9.

In an implementation mode, a curvature radius R3 of an object-side surface of the second lens and a curvature radius R4 of the image-side surface of the second lens may satisfy 0.2<R4/R3<0.8.

In an implementation mode, a maximum effective radius DT41 of the object-side surface of the fourth lens and a maximum effective radius DT51 of an object-side surface of the fifth lens may satisfy DT51/DT41<1.

In an implementation mode, a curvature radius R1 of the object-side surface of the first lens and an effective focal length f1 of the first lens may satisfy |R1/f1|≤0.60.

In an implementation mode, a spacing distance T56 between the fifth lens and the sixth lens on the optical axis, a spacing distance T67 between the sixth lens and the seventh lens on the optical axis, a spacing distance T78 between the seventh lens and the eighth lens on the optical axis and a spacing distance TTL from the object-side surface of the first lens to an imaging surface of the optical imaging system on the optical axis may satisfy 0<(T56+T67+T78)/TTL<0.4.

In an implementation mode, a center thickness CT1 of the first lens on the optical axis and a center thickness CT3 of the third lens on the optical axis may satisfy 0.2<CT3/CT1<1.0.

In an implementation mode, a center thickness CT4 of the fourth lens on the optical axis and a center thickness CT5 of the fifth lens on the optical axis may satisfy 0.3<CT5/CT4<1.0.

In an implementation mode, a curvature radius R13 of the object-side surface of the seventh lens and a total effective focal length f of the optical imaging system may satisfy 0.1<R13/f<1.0.

In an implementation mode, the spacing distance TTL from the object-side surface of the first lens to the imaging surface of the optical imaging system on the optical axis and the total effective focal length f of the optical imaging system may satisfy TTL/f≤1.18.

In an implementation mode, a curvature radius R9 of the object-side surface of the fifth lens and a curvature radius R10 of an image-side surface of the fifth lens may satisfy 0.5<|R10/R9|<1.

According to the disclosure, eight lenses are adopted, and refractive power and surface types of each lens, a center thickness of each lens, on-axis distances between the lenses, etc., are reasonably configured to achieve at least one beneficial effect of long focal length, large aperture, small size, etc., of the optical imaging system.

### BRIEF DESCRIPTION OF THE DRAWINGS

Detailed descriptions are made to unrestrictive embodiments below in combination with the drawings to make the other characteristics, purposes and advantages of the disclosure more apparent. In the drawings:

FIG. 1 shows a structural schematic diagram of an optical imaging system according to Embodiment 1 of the disclosure;

FIGS. 2A-2D show a longitudinal aberration curve, an astigmatism curve, a distortion curve and a lateral color curve of an optical imaging system according to Embodiment 1 respectively;

FIG. 3 shows a structural schematic diagram of an optical imaging system according to Embodiment 2 of the disclosure;

FIGS. 4A-4D show a longitudinal aberration curve, an astigmatism curve, a distortion curve and a lateral color curve of an optical imaging system according to Embodiment 2 respectively;

FIG. 5 shows a structural schematic diagram of an optical imaging system according to Embodiment 3 of the disclosure;

FIGS. 6A-6D show a longitudinal aberration curve, astigmatism curve, distortion curve, and lateral color curve of an optical imaging system according to Embodiment 3 respectively;

FIG. 7 shows a structural schematic diagram of an optical imaging system according to Embodiment 4 of the disclosure;

FIGS. 8A-8D show a longitudinal aberration curve, an astigmatism curve, a distortion curve and a lateral color curve of an optical imaging system according to Embodiment 4 respectively;

FIG. 9 shows a structural schematic diagram of an optical imaging system according to Embodiment 5 of the disclosure;

FIGS. 10A-10D show a longitudinal aberration curve, an astigmatism curve, a distortion curve and a lateral color curve of an optical imaging system according to Embodiment 5 respectively;

FIG. 11 shows a structural schematic diagram of an optical imaging system according to Embodiment 6 of the disclosure;

FIGS. 12A-12D show a longitudinal aberration curve, an astigmatism curve, a distortion curve and a lateral color curve of an optical imaging system according to Embodiment 6 respectively;

FIG. 13 shows a structural schematic diagram of an optical imaging system according to Embodiment 7 of the disclosure;

FIGS. 14A-14D show a longitudinal aberration curve, an astigmatism curve, a distortion curve and a lateral color curve of an optical imaging system according to Embodiment 7 respectively;

FIG. 15 shows a structural schematic diagram of an optical imaging system according to Embodiment 8 of the disclosure; and

FIGS. 16A-16D show a longitudinal aberration curve, an astigmatism curve, a distortion curve and a lateral color curve of an optical imaging system according to Embodiment 8 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc., are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It should also be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging system according to an exemplary embodiment of the disclosure may include, for example, eight lenses with refractive power, i.e., a first lens, a second lens, a third lens, a fourth lens, a fifth lens, a sixth lens, a seventh lens and an eighth lens. The eight lenses are sequentially arranged from an object side to an image side along an optical axis. In the first lens to the eighth lens, there may be an air space between any two adjacent lenses.

In the exemplary embodiment, the first lens may have a positive refractive power or a negative refractive power. Exemplarily, the second lens may have a negative refractive power. Exemplarily, the third lens may have a positive refractive power or a negative refractive power, the fourth lens may have a positive refractive power or a negative refractive power, the fifth lens may have a positive refractive power or a negative refractive power, the sixth lens may have a positive refractive power or a negative refractive power, the seventh lens may have a positive refractive power or a negative refractive power, and the eighth lens may have a positive refractive power or a negative positive power.

In the exemplary embodiment, when an image-side surface of the first lens is a convex surface, an image-side surface of the second lens is a concave surface, and an object-side surface of the seventh lens is a convex surface, or, when the image-side surface of the second lens is a concave surface, an object-side surface of the fifth lens is a convex surface, and the object-side surface of the seventh lens is a convex surface, appropriate refractive power of each lens is ensured favorably, and an aberration of the optical imaging system is balanced and controlled favorably.

In the exemplary embodiment, the optical imaging system of the disclosure may satisfy a conditional expression Semi-FOV<30°, wherein Semi-FOV is a half of a maximum field of view of the optical imaging system. Exemplarily, Semi-FOV may satisfy Semi-FOV<22.5°, and more specifically, may satisfy 20.0° <Semi-F0V<22.0°. The optical imaging system of the disclosure may image a relatively far object clearly, and may further be used for a multi-lens group, to ensure that the multi-lens group at least has a telephoto end.

In the exemplary embodiment, the optical imaging system of the disclosure may satisfy a conditional expression f/EPD≤1.3, wherein f is a total effective focal length of the optical imaging system, and EPD is an Entrance Pupil Diameter of the optical imaging system. More specifically, f and EPD may satisfy 1.05<f/EPD≤1.3. A ratio of the total effective focal length to EPD of the optical imaging system may be controlled to ensure that the optical imaging system has a relatively large aperture and help to improve an incident flux of the optical imaging system and further improve the illuminance and imaging quality of the optical imaging system.

In the exemplary embodiment, the optical imaging system of the disclosure may satisfy a conditional expression DT81/DT11≤0.87, wherein DT11 is a maximum effective radius of an object-side surface of the first lens, and DT81 is a maximum effective radius of an object-side surface of the eighth lens. More specifically, DT11 and DT81 may satisfy 0.7<DT81/DT11≤0.87. A ratio of the maximum effective radii of the object-side surfaces of the first lens and the eighth lens is controlled to help to reduce a size of the first lens and effectively reduce a size of the optical imaging system.

In the exemplary embodiment, the optical imaging system of the disclosure may satisfy a conditional expression 0.1<SAG41/SAG31<0.9, wherein SAG41 is an on-axis distance from an intersection point of an object-side surface of the fourth lens and an optical axis to an effective radius vertex of the object-side surface of the fourth lens, and SAG31 is an on-axis distance from an intersection point of the object-side surface of the third lens and the optical axis to an effective radius vertex of the object-side surface of the third lens. More specifically, SAG41 and SAG31 may satisfy 0.4<SAG41/SAG31<0.6. A ratio of a vector height of the object-side surface of the fourth lens to a vector height of the object-side surface of the third lens is controlled to help to control respective refractive power of the third lens and the fourth lens to further make the refractive power of each lens of the optical imaging system relatively balanced and effectively balance an aberration contribution of each lens.

In the exemplary embodiment, the optical imaging system of the disclosure may satisfy a conditional expression 0.2<R4/R3<0.8, wherein R3 is a curvature radius of an object-side surface of the second lens, and R4 is a curvature radius of the image-side surface of the second lens. More specifically, R3 and R4 may satisfy 0.53<R4/R3<0.63. A ratio of the curvature radii of the two mirror surfaces of the second lens is controlled to help to control a shape of the second lens to further endow the second lens with relatively high machinability, and in addition, help to make the refractive power of each lens of the optical imaging system relatively balanced.

In the exemplary embodiment, the optical imaging system of the disclosure may satisfy a conditional expression DT51/DT41<1, wherein DT41 is a maximum effective radius of the object-side surface of the fourth lens, and DT51 is the maximum effective radius of the object-side surface of the fifth lens. More specifically, DT41 and DT51 may satisfy 0.80<DT51/DT41<0.95. A ratio of the maximum effective radii of the object-side surfaces of the fourth lens and the fifth lens is controlled to help to control a shape of the fourth lens and a shape of the fifth lens to further improve respective machinability of the fourth lens and the fifth lens and improve the assembling manufacturability of the optical imaging system and also help to improve the imaging quality of the optical imaging system.

In the exemplary embodiment, the optical imaging system of the disclosure may satisfy a conditional expression |R1/f1|≤0.60, wherein R1 is a curvature radius of the object-side surface of the first lens, and f1 is an effective focal length of the first lens. More specifically, R1 and f1 may satisfy 0.55<|R1/f1|≤0.60. The curvature radius of the object-side surface of the first lens is matched with the effective focal length thereof to help to control the refractive power of the first lens and restrict a machining field angle of the first lens to further improve the machinability of the first lens.

In the exemplary embodiment, the optical imaging system of the disclosure may satisfy a conditional expression 0<(T56+T67+T78)/TTL<0.4, wherein T56 is a spacing distance between the fifth lens and the sixth lens on the optical axis, T67 is a spacing distance between the sixth lens and the seventh lens on the optical axis, T78 is a spacing distance between the seventh lens and the eighth lens on the optical axis, and TTL is a spacing distance from the object-side surface of the first lens to an imaging surface of the optical imaging system on the optical axis. More specifically, T56, T67, T78 and TTL may satisfy 0.15<(T56+T67+T78)/TTL<0.25. A sum of the spacing distances between adjacent lenses in the fifth lens to the eighth lens is matched to the total track length of the optical imaging system to help to reduce the total track length of the optical imaging system and effectively reduce the overall size of the optical imaging system to highlight the characteristic of small size of the optical imaging system. The optical imaging system occupies a relatively small assembling space, and is more applicable to a device.

In the exemplary embodiment, the optical imaging system of the disclosure may satisfy a conditional expression 0.2<CT3/CT1<1.0, wherein CT1 is a center thickness of the first lens on the optical axis, and CT3 is a center thickness of the third lens on the optical axis. More specifically, CT1 and CT3 may satisfy 0.50<CT3/CT1<0.75. A ratio of the center thickness of the third lens to the center thickness of the first lens is controlled to help to reduce the center thickness of the first lens and the center thickness of the third lens and further help to further reduce the total track length of the optical imaging system to effectively reduce the size of the optical imaging system.

In the exemplary embodiment, the optical imaging system of the disclosure may satisfy a conditional expression 0.3<CT5/CT4<1.0, wherein CT4 is a center thickness of the fourth lens on the optical axis, and CT5 is a center thickness of the fifth lens on the optical axis. More specifically, CT4 and CT5 may satisfy 0.55<CT5/CT4<0.85. A ratio of the center thickness of the fifth lens to the center thickness of the fourth lens is controlled to help to reduce the center thickness of the fourth lens and the center thickness of the fifth lens and further help to further reduce the total track length of the optical imaging system to effectively reduce the size of the optical imaging system.

In the exemplary embodiment, the optical imaging system of the disclosure may satisfy a conditional expression 0.1<R13/f<1.0, wherein R12 is a curvature radius of the object-side surface of the seventh lens, and f is the total effective focal length of the optical imaging system. More specifically, R13 and f may satisfy 0.45<R13/f<0.80. A ratio of the curvature radius of the object-side surface of the seventh lens to the total effective focal length may be controlled to effectively control a shape and refractive power of the seventh lens to ensure that the refractive power of the seventh lens is matched with the total refractive power of the optical imaging system and further help to balance the refractive power of each lens.

In the exemplary embodiment, the optical imaging system of the disclosure may satisfy a conditional expression TTL/f≤1.18, wherein TTL is the spacing distance from the object-side surface of the first lens to the imaging surface of the optical imaging system on the optical axis, and f is the total effective focal length of the optical imaging system. More specifically, TTL and f may satisfy 1.09≤TTL/f≤1.18. A ratio of the total track length to the total effective focal length of the optical imaging system is controlled to help to control the total track length to ensure a relatively long focal length of the optical imaging system under a limited total track length and ensure higher imaging quality when the optical imaging system shoots a relatively far object.

In the exemplary embodiment, the optical imaging system of the disclosure may satisfy a conditional expression 0.5<|R10/R9|<1, wherein R9 is a curvature radius of the object-side surface of the fifth lens, and R10 is a curvature radius of an image-side surface of the fifth lens. More specifically, R9 and R10 may satisfy 0.78<|R10/R9|<0.87. A ratio of the curvature radii of the two mirror surfaces of the fifth lens is controlled to help to control a shape of the fifth lens to further endow the fifth lens with relatively high machinability, and in addition, ensure that the refractive power of the fifth lens is matched with the total refractive power of the optical imaging system.

In the exemplary embodiment, the optical imaging system may further include at least one diaphragm. The diaphragm may be arranged at a proper position as required, for example, arranged between the object side and the first lens. Optionally, the optical imaging system may further include an optical filter configured to correct a chromatic aberration and/or protective glass configured to protect a photosensitive element on the imaging surface.

The optical imaging system according to the embodiment of the disclosure may adopt multiple lenses, for example, the abovementioned eight. The refractive power and surface types of each lens, the center thickness of each lens, on-axis distances between the lenses, etc., are reasonably configured to effectively reduce the size of the optical imaging system, reduce the sensitivity of the optical imaging system, improve the machinability of the optical imaging system, and ensure that the optical imaging system is more favorable for production and machining and applicable to a portable electronic product. In addition, the optical imaging system of the disclosure also has high optical performance such as long focal length, large aperture, and small size.

In the embodiment of the disclosure, at least one of the mirror surfaces of each lens is an aspheric mirror surface, namely at least one of the object-side surface of the first lens to the image-side surface of the eighth lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatism aberrations. With adoption of the aspheric lens, aberrations during imaging may be eliminated as much as possible, thereby improving the imaging quality. Optionally, at least one of the object-side surface and the image-side surface of each lens in the first lens, the second lens, the third lens, the fourth lens, the fifth lens, the sixth lens, the seventh lens and the eighth lens is an aspheric mirror surface. Optionally, both the object-side surface and the image-side surface of each lens in the first lens, the second lens, the third lens, the fourth lens, the fifth lens, the sixth lens, the seventh lens and the eighth lens are aspheric mirror surfaces.

However, those skilled in the art should know that the number of the lenses forming the optical imaging system may be changed without departing from the technical solutions claimed in the disclosure to achieve each result and advantage described in the specification. For example, although descriptions are made in the embodiment with eight lenses as an example, the optical imaging system is not limited to include eight lenses. If necessary, the optical imaging system may also include another number of lenses.

Specific embodiments applied to the optical imaging system of the abovementioned embodiment will further be described below with reference to the drawings.

### Embodiment 1

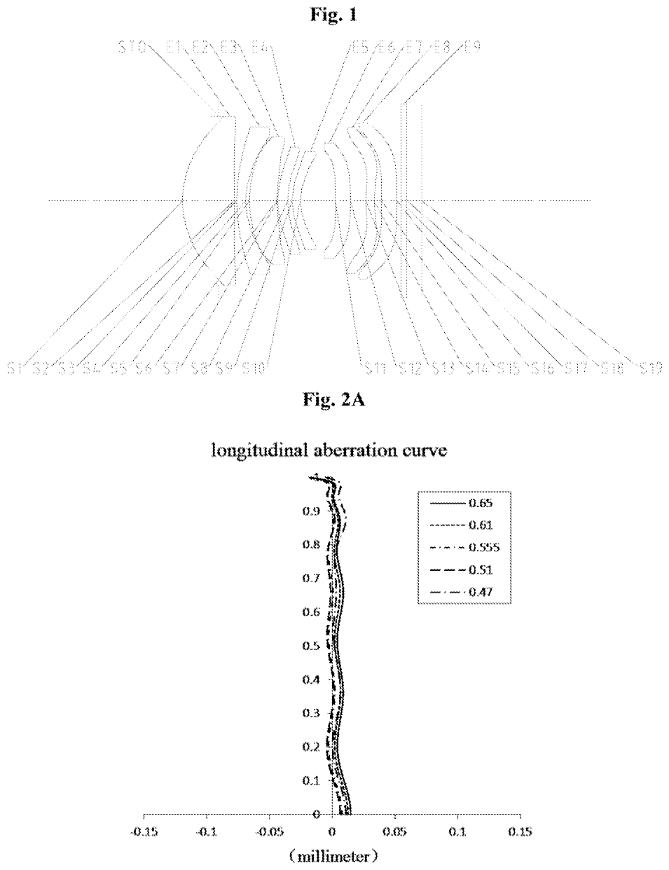

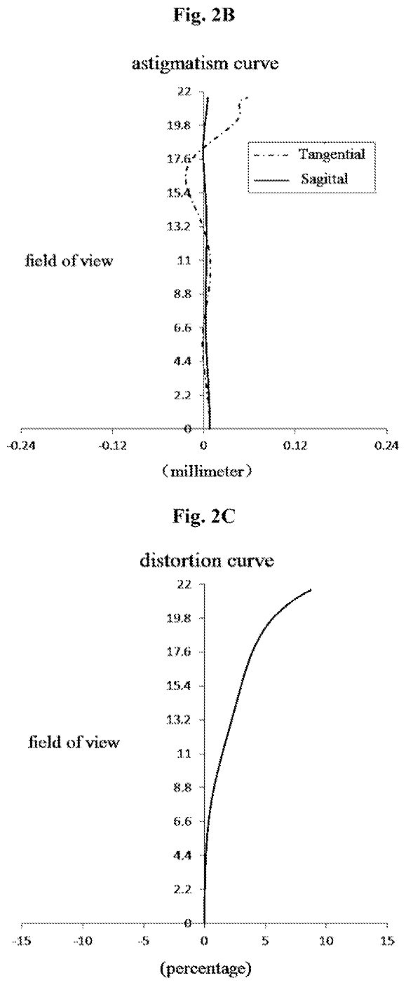

An optical imaging system according to Embodiment 1 of the disclosure will be described below with reference to FIGS. 1-2D. FIG. 1 shows a structural schematic diagram of an optical imaging system according to Embodiment 1 of the disclosure.

As shown in FIG. 1, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens El has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface 511 thereof is a convex surface, and an image-side surface S12 thereof is a convex surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

Table 1 shows a basic parameter table of the optical imaging system of Embodiment 1, wherein the units of the curvature radius, the thickness/distance and the focal length are all millimeters (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.3000 | | | | |
| S1 | Aspheric | 3.4737 | 1.8863 | 1.54 | 55.80 | 5.81 | 0.0000 |
| S2 | Aspheric | −24.7516 | 0.0774 | | | | 0.0000 |
| S3 | Aspheric | 5.0654 | 0.3400 | 1.68 | 19.25 | −9.62 | 0.0000 |
| S4 | Aspheric | 2.7728 | 0.1363 | | | | 0.0000 |
| S5 | Aspheric | 5.0042 | 0.9842 | 1.54 | 55.80 | −24.62 | 0.0000 |
| S6 | Aspheric | 3.3803 | 0.0400 | | | | 0.0000 |
| S7 | Aspheric | 3.0348 | 0.3727 | 1.54 | 55.80 | 9.76 | 0.0000 |
| S8 | Aspheric | 6.9058 | 0.1477 | | | | 0.0000 |
| S9 | Aspheric | 2.1095 | 0.3000 | 1.65 | 23.53 | −19.44 | 0.0000 |
| S10 | Aspheric | 1.7049 | 1.2733 | | | | 0.0000 |
| S11 | Aspheric | 462.4822 | 0.5500 | 1.68 | 19.25 | 25.78 | 0.0000 |
| S12 | Aspheric | −18.1464 | 0.5629 | | | | 0.0000 |
| S13 | Aspheric | 4.5551 | 0.3000 | 1.54 | 55.80 | −16.30 | 0.0000 |
| S14 | Aspheric | 2.9269 | 0.2726 | | | | 0.0000 |
| S15 | Aspheric | 41.5202 | 0.5525 | 1.68 | 19.25 | −43.56 | 0.0000 |
| S16 | Aspheric | 17.1600 | 0.1523 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

In Embodiment 1, a value of a total effective focal length f of the optical imaging system is 7.98 mm, a value of an on-axis distance TTL from the object-side surface S1 of the first lens E1 to the imaging surface S19 is 8.70 mm, ImgH is a half of a diagonal length of an effective pixel region on the imaging surface S19, and a value of ImgH is 3.43 mm, Semi-FOV is a half of a maximum field of view, and a value of Semi-FOV is 21.61°, and a value of the F-number (Fno) of the optical imaging system is 1.30.

In Embodiment 1, both the object-side surface and the image-side surface of any lens in the first lens E1 to the eighth lens E8 are aspheric surfaces, and a surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} , \qquad ( 1 )$$

wherein x is a vector height of a distance between the aspheric surface and a vertex of the aspheric surface when the aspheric surface is located at a position with the height h along the optical axis direction, c=1/R (namely, the paraxial curvature c is a reciprocal of the curvature radius R in Table 1 above); k is a conic coefficient; and Ai is a correction coefficient of the i-th order of the aspheric surface. Table 2 shows higher-order coefficients A4, A6, A8, A10, Al2, A14, A16, A18 and A20 that can be used for each of the aspheric mirror surfaces S1-S16 in Embodiment 1.

TABLE 2

| Surface number | A4 | A6 | A8 | A10 | A12 | A14 | A16 | A18 | A20 |
|---|---|---|---|---|---|---|---|---|---|
| S1 | −8.4581E−04 | −1.4862E−04 | 9.9297E−06 | −5.0798E−07 | −9.9798E−07 | 2.5979E−07 | −3.6451E−08 | 2.4227E−09 | −6.1355E−11 |
| S2 | 6.3103E−03 | 4.9251E−04 | −2.5899E−04 | 1.4646E−05 | 2.2693E−06 | −3.0603E−07 | 1.0603E−08 | 0.0000E+00 | 0.0000E+00 |
| S3 | −1.8083E−02 | 3.8322E−03 | 3.2383E−04 | −3.4201E−04 | 6.5606E−05 | −5.0970E−06 | 1.2209E−07 | 1.7279E−09 | 0.0000E+00 |
| S4 | −2.4387E−02 | 7.1184E−03 | −2.1316E−03 | 4.7043E−04 | −7.6618E−05 | 4.9190E−06 | 3.7068E−07 | −4.9076E−08 | 0.0000E+00 |
| S5 | −5.5888E−04 | 1.1094E−02 | −5.9571E−03 | 1.6572E−03 | −2.4335E−04 | 1.7641E−05 | −4.5972E−07 | 0.0000E+00 | 0.0000E+00 |
| S6 | −1.0029E−01 | 5.0060E−02 | −1.6509E−02 | 3.1216E−03 | −1.3973E−04 | −4.3524E−05 | 4.5945E−06 | 6.0271E−08 | 0.0000E+00 |
| S7 | −9.2730E−03 | 1.0104E−02 | −1.7386E−02 | 8.6327E−03 | −1.8260E−03 | 1.4119E−04 | −1.7086E−07 | 1.1812E−07 | 0.0000E+00 |
| S8 | 1.2192E−01 | −4.9273E−02 | −6.1404E−03 | 1.0700E−02 | −3.7145E−03 | 5.4234E−04 | −2.1697E−05 | −1.0303E−06 | 0.0000E+00 |
| S9 | −5.8760E−02 | 6.3996E−03 | 2.1661E−03 | −3.9077E−03 | 1.7098E−03 | −3.3384E−04 | 2.8609E−05 | −1.2463E−06 | 0.0000E+00 |
| S10 | −1.1721E−01 | 6.7508E−02 | −1.0632E−01 | 1.5805E−01 | −1.6123E−01 | 1.0304E−01 | −3.9641E−02 | 8.4024E−03 | −7.5697E−04 |
| S11 | −2.1902E−02 | 1.0901E−03 | −8.5388E−03 | 6.6021E−03 | −3.0419E−03 | 6.7900E−04 | −4.9182E−05 | −5.3913E−07 | −1.1116E−07 |
| S12 | −2.5838E−02 | 6.0497E−03 | −7.3894E−03 | 4.3337E−03 | −1.5433E−03 | 2.8918E−04 | −2.0239E−05 | 2.3189E−07 | −6.9718E−08 |
| S13 | −8.7128E−02 | 3.9503E−03 | 5.3564E−03 | −1.9759E−03 | 2.9056E−04 | −1.4670E−05 | −6.0004E−08 | 1.4079E−10 | −2.4508E−10 |
| S14 | −9.2880E−02 | 1.2841E−02 | 4.9539E−04 | −1.0963E−03 | 2.4921E−04 | −1.8789E−05 | −3.2355E−07 | 9.5551E−08 | −2.8418E−09 |
| S15 | −5.4844E−02 | 2.4371E−02 | −7.7130E−03 | 1.1052E−03 | −5.2881E−05 | −1.3503E−06 | 1.2587E−07 | −2.2431E−09 | 2.3164E−10 |
| S16 | −5.9574E−02 | 2.1618E−02 | −5.5450E−03 | 7.4377E−04 | −4.2553E−05 | −9.0272E−07 | 2.2985E−07 | −1.2749E−08 | 6.1933E−10 |

FIG. 2A shows a longitudinal aberration curve of the optical imaging system according to Embodiment 1 to represent deviation of a convergence focal point after light with different wavelengths passes through the system. FIG. 2B shows an astigmatism curve of the optical imaging system according to Embodiment 1 to represent a curvature of tangential image surface and a curvature of sagittal image surface. FIG. 2C shows a distortion curve of the optical imaging system according to Embodiment 1 to represent distortion values corresponding to different fields of view. FIG. 2D shows a lateral color curve of the optical imaging system according to Embodiment 1 to represent deviation of different image heights on the imaging surface after the light passes through the system. According to FIGS. 2A-2D, it can be seen that the optical imaging system provided in Embodiment 1 may achieve high imaging quality.

### Embodiment 2

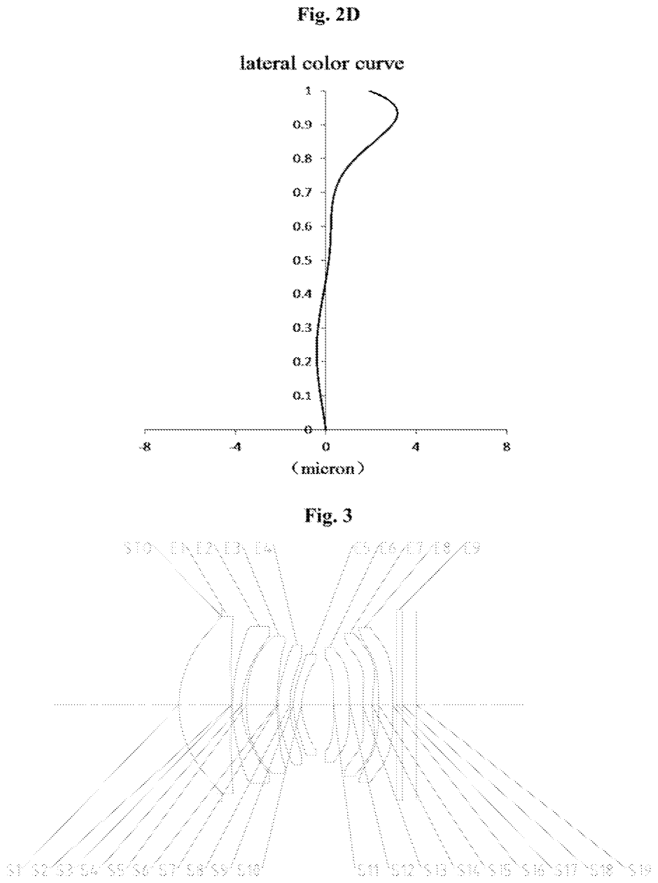

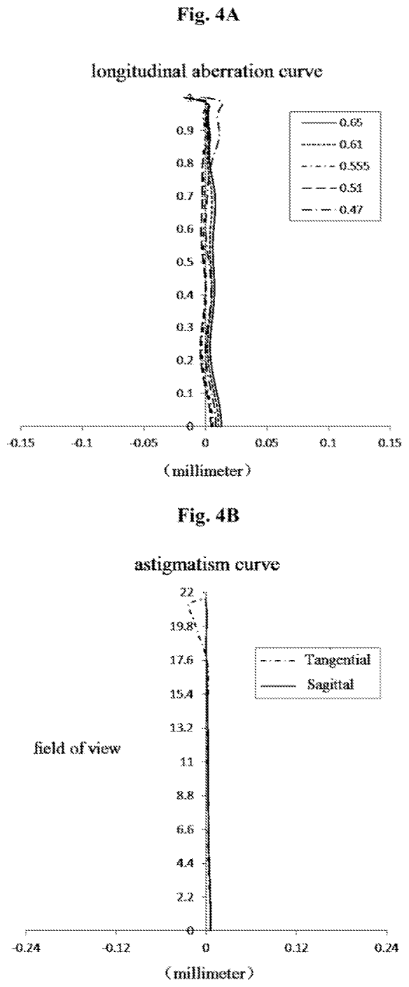

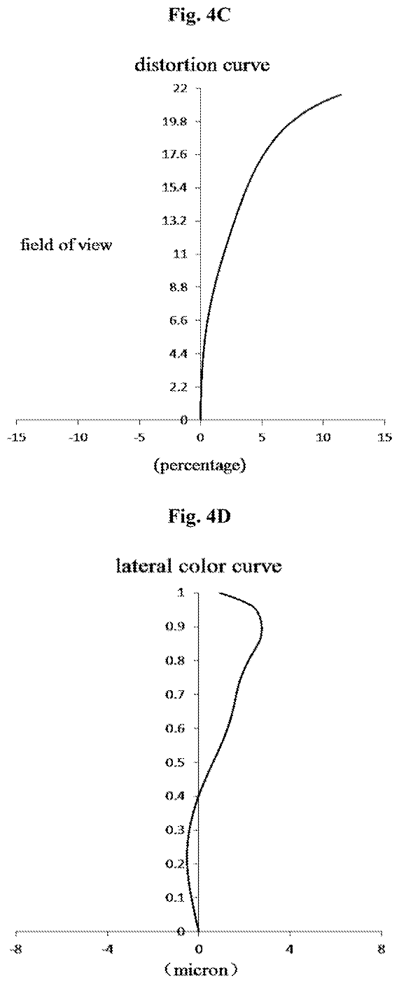

An optical imaging system according to Embodiment 2 of the disclosure will be described below with reference to FIGS. 3-4D. In the embodiment and the following embodiments, part of descriptions similar to those about Embodiment 1 is omitted for simplicity. FIG. 3 shows a structural schematic diagram of an optical imaging system according to Embodiment 2 of the disclosure.

As shown in FIG. 3, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 2, a value of a total effective focal length f of the optical imaging system is 7.80 mm, a value of an on-axis distance TTL from the object-side surface S1 of the first lens E1 to the imaging surface S19 is 8.80 mm, ImgH is a half of a diagonal length of an effective pixel region on the imaging surface S19, and a value of ImgH is 3.43 mm, Semi-FOV is a half of a maximum field of view, and a value of Semi-FOV is 21.56°, and a value of the Fno of the optical imaging system is 1.20.

Table 3 shows a basic parameter table of the optical imaging system of Embodiment 2, wherein the units of the curvature radius, the thickness/distance and the focal length are all millimeters (mm). Table 4 shows high-order coefficients applied to each aspheric mirror surface in Embodiment 2. A surface type of each aspheric surface may be defined by formula (1) given in Embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.5811 | 1.9427 | 1.54 | 55.80 | 5.97 | 0.0000 |
| S2 | Aspheric | −24.6227 | 0.0352 | | | | 0.0000 |
| S3 | Aspheric | 5.1896 | 0.3435 | 1.68 | 19.25 | −9.95 | 0.0000 |
| S4 | Aspheric | 2.8539 | 0.1702 | | | | 0.0000 |
| S5 | Aspheric | 4.8860 | 1.1230 | 1.54 | 55.80 | −46.99 | 0.0000 |
| S6 | Aspheric | 3.7645 | 0.0460 | | | | 0.0000 |
| S7 | Aspheric | 3.2542 | 0.4484 | 1.54 | 55.80 | 13.57 | 0.0000 |
| S8 | Aspheric | 5.5987 | 0.1240 | | | | 0.0000 |
| S9 | Aspheric | 2.1951 | 0.3000 | 1.68 | 19.25 | −28.19 | 0.0000 |
| S10 | Aspheric | 1.8601 | 1.1848 | | | | 0.0000 |
| S11 | Aspheric | 196.1137 | 0.6017 | 1.68 | 19.25 | 34.12 | 0.0000 |
| S12 | Aspheric | −26.1771 | 0.4765 | | | | 0.0000 |
| S13 | Aspheric | 4.1267 | 0.3502 | 1.54 | 55.80 | −33.31 | 0.0000 |
| S14 | Aspheric | 3.2535 | 0.2381 | | | | 0.0000 |
| S15 | Aspheric | 517.4550 | 0.5189 | 1.68 | 19.25 | −22.60 | 0.0000 |
| S16 | Aspheric | 14.8693 | 0.1450 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 4

| Surface | | | | | | | | | |
|---|---|---|---|---|---|---|---|---|---|
| number | A4 | A6 | A8 | A10 | A12 | A14 | A16 | A18 | A20 |
| S1 | −1.0999E−03 | −6.8705E−05 | −3.6452E−05 | 1.6035E−05 | −4.3954E−06 | 6.9764E−07 | −6.9915E−08 | 3.9000E−09 | −9.2004E−11 |
| S2 | 4.8678E−03 | 3.9769E−04 | −9.8894E−05 | −1.4859E−05 | 4.3812E−06 | −3.5031E−07 | 9.7302E−09 | 0.0000E+00 | 0.0000E+00 |
| S3 | −1.2260E−02 | 1.4121E−03 | 6.2931E−04 | −2.6565E−04 | 3.9488E−05 | −2.5589E−06 | 5.4748E−08 | 2.6707E−10 | 1.5114E−11 |
| S4 | −1.6379E−02 | 3.0816E−03 | −8.4031E−04 | 2.2306E−04 | −5.8740E−05 | 1.1048E−05 | −1.4874E−06 | 1.3127E−07 | −5.4726E−09 |
| S5 | −1.0642E−03 | 7.3851E−03 | −3.2272E−03 | 7.4510E−04 | −9.1185E−05 | 6.1291E−06 | −2.5953E−07 | 1.2820E−08 | −8.5576E−10 |
| S6 | −7.3385E−02 | 2.5840E−02 | −3.4342E−03 | −1.0551E−03 | 5.7726E−04 | −9.8252E−05 | 5.5386E−06 | 5.5853E−08 | 0.0000E+00 |
| S7 | −8.9671E−04 | −6.7073E−03 | −9.4884E−04 | 9.5800E−04 | −3.0328E−05 | −4.7725E−05 | 5.7345E−06 | 2.0554E−08 | 1.0566E−08 |
| S8 | 9.3471E−02 | −3.4969E−02 | −5.7553E−03 | 7.2428E−03 | −2.2420E−03 | 3.0236E−04 | −1.3243E−05 | −4.9228E−08 | −2.7059E−08 |
| S9 | −5.8804E−02 | 1.2458E−02 | −1.5305E−03 | −3.1268E−03 | 1.7832E−03 | −3.2601E−04 | 2.4690E−06 | 4.1965E−06 | −2.4783E−07 |
| S10 | −1.0007E−01 | 3.8174E−02 | −1.7400E−02 | 3.3743E−03 | 1.2855E−03 | −1.0932E−03 | 3.2277E−04 | −3.7856E−05 | 0.0000E+00 |
| S11 | −2.3304E−02 | 9.2170E−04 | −5.3761E−03 | 3.3896E−03 | −1.4899E−03 | 3.2443E−04 | −2.2233E−05 | −1.1131E−07 | −7.3632E−08 |
| S12 | −3.6139E−02 | 1.0680E−02 | −7.5258E−03 | 3.3307E−03 | −1.0056E−03 | 1.7419E−04 | −1.2040E−05 | 2.5807E−07 | −4.9712E−08 |
| S13 | −8.3830E−02 | −2.9439E−03 | 9.0437E−03 | −3.3930E−03 | 5.9696E−04 | −4.5177E−05 | 9.3282E−07 | 3.8790E−09 | 6.4870E−10 |
| S14 | −7.3315E−02 | −9.8581E−04 | 7.5097E−03 | −3.3104E−03 | 6.5274E−04 | −5.8209E−05 | 1.7427E−06 | 6.4850E−09 | 1.2398E−09 |
| S15 | −5.3565E−02 | 2.4799E−02 | −8.3942E−03 | 1.4320E−03 | −1.1077E−04 | 3.0216E−06 | 6.8725E−09 | 5.2894E−11 | 1.6593E−11 |
| S16 | −5.8378E−02 | 2.3215E−02 | −7.3270E−03 | 1.4214E−03 | −1.6092E−04 | 9.2608E−06 | −1.7972E−07 | 8.5716E−10 | −1.4875E−10 |

FIG. 4A shows a longitudinal aberration curve of the optical imaging system according to Embodiment 2 to represent deviation of a convergence focal point after light with different wavelengths passes through the system. FIG. 4B shows an astigmatism curve of the optical imaging system according to Embodiment 2 to represent a curvature of tangential image surface and a curvature of sagittal image surface. FIG. 4C shows a distortion curve of the optical imaging system according to Embodiment 2 to represent distortion values corresponding to different fields of view. FIG. 4D shows a lateral color curve of the optical imaging system according to Embodiment 2 to represent deviation of different image heights on the imaging surface after the light passes through the system. According to FIGS. 4A-4D, it can be seen that the optical imaging system provided in Embodiment 2 may achieve high imaging quality.

### Embodiment 3

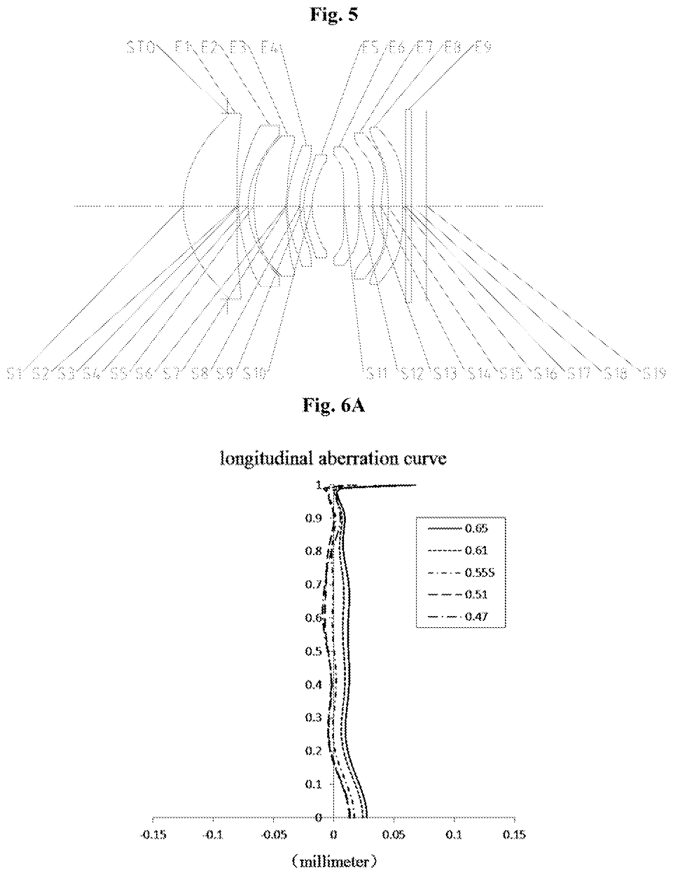

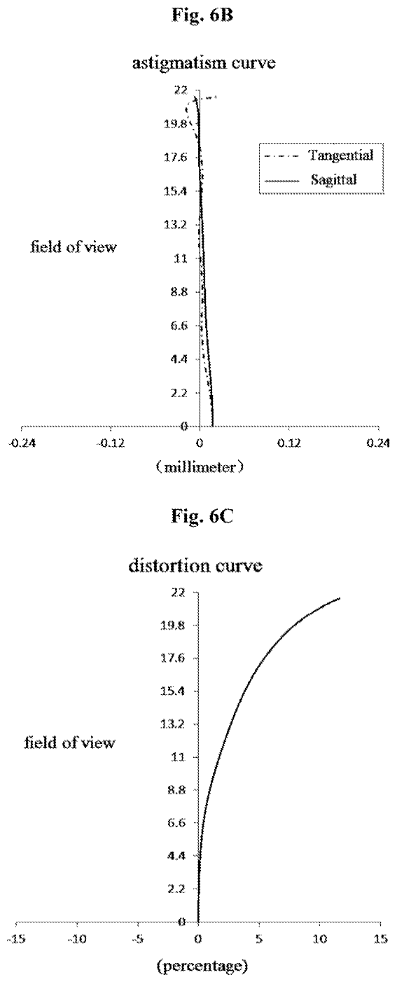

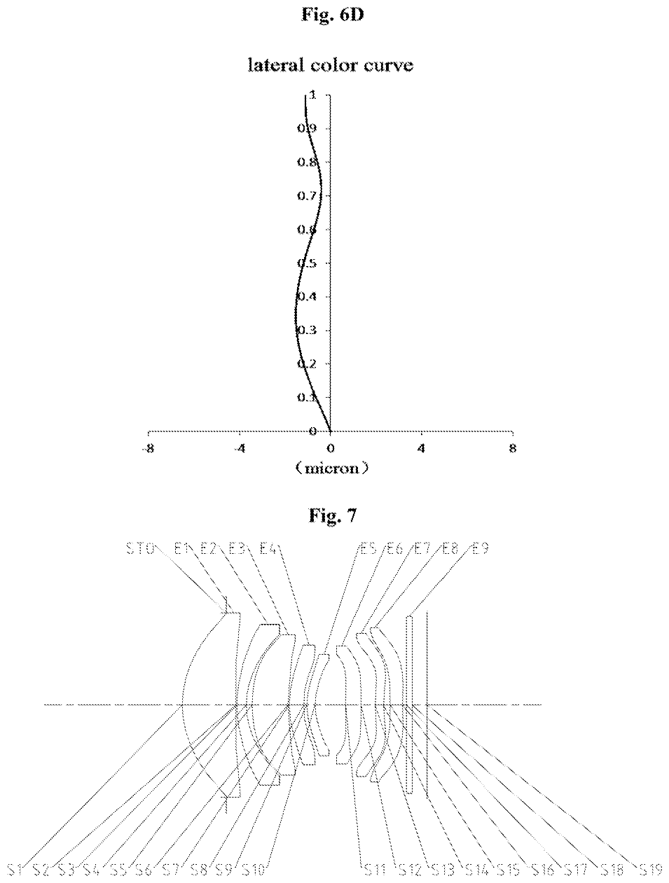

An optical imaging system according to Embodiment 3 of the disclosure will be described below with reference to FIGS. 5-6D. FIG. 5 shows a structural schematic diagram of an optical imaging system according to Embodiment 3 of the disclosure.

As shown in FIG. 5, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 3, a value of a total effective focal length f of the optical imaging system is 7.80 mm, a value of an on-axis distance TTL from the object-side surface S1 of the first lens E1 to the imaging surface S19 is 8.80 mm, ImgH is a half of a diagonal length of an effective pixel region on the imaging surface S19, and a value of ImgH is 3.43 mm, Semi-FOV is a half of a maximum field of view, and a value of Semi-FOV is 21.58°, and a value of the Fno of the optical imaging system is 1.16.

Table 5 shows a basic parameter table of the optical imaging system of Embodiment 3, wherein the units of the curvature radius, the thickness/distance and the focal length are all millimeters (mm). Table 6 shows high-order coefficients applied to each aspheric mirror surface in Embodiment 3. A surface type of each aspheric surface may be defined by formula (1) given in Embodiment 1.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.6619 | 1.9500 | 1.54 | 55.80 | 6.37 | 0.0000 |
| S2 | Aspheric | −42.2162 | 0.0501 | | | | 0.0000 |
| S3 | Aspheric | 4.5044 | 0.3468 | 1.68 | 19.25 | −11.19 | 0.0000 |
| S4 | Aspheric | 2.7381 | 0.2094 | | | | 0.0000 |
| S5 | Aspheric | 5.0233 | 1.1546 | 1.54 | 55.80 | −70.77 | 0.0000 |
| S6 | Aspheric | 4.0804 | 0.0450 | | | | 0.0000 |
| S7 | Aspheric | 3.2295 | 0.4637 | 1.54 | 55.80 | 12.64 | 0.0000 |
| S8 | Aspheric | 5.8553 | 0.1297 | | | | 0.0000 |
| S9 | Aspheric | 2.3309 | 0.3000 | 1.68 | 19.25 | −20.58 | 0.0000 |
| S10 | Aspheric | 1.8932 | 1.1653 | | | | 0.0000 |
| S11 | Aspheric | 24.4828 | 0.5500 | 1.68 | 19.25 | 36.79 | 0.0000 |
| S12 | Aspheric | 1364.8931 | 0.4862 | | | | 0.0000 |
| S13 | Aspheric | 3.8457 | 0.3000 | 1.54 | 55.80 | −46.95 | 0.0000 |
| S14 | Aspheric | 3.2456 | 0.2590 | | | | 0.0000 |
| S15 | Aspheric | −545.5373 | 0.5137 | 1.68 | 19.25 | −18.71 | 0.0000 |
| S16 | Aspheric | 12.9844 | 0.1246 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 6

| Surface | | | | | | | | | |
|---|---|---|---|---|---|---|---|---|---|
| number | A4 | A6 | A8 | A10 | A12 | A14 | A16 | A18 | A20 |
| S1 | −9.5116E−04 | −1.0364E−04 | −2.6724E−05 | 1.6176E−05 | −4.7581E−06 | 7.4833E−07 | −7.0579E−08 | 3.6592E−09 | −8.0243E−11 |
| S2 | 4.3136E−03 | 7.0713E−04 | −2.2207E−04 | 1.2389E−05 | 1.1231E−06 | −1.5157E−07 | 4.8449E−09 | 0.0000E+00 | 0.0000E+00 |
| S3 | −1.3291E−02 | 2.5164E−03 | 1.2074E−04 | −1.4763E−04 | 2.4588E−05 | −1.6124E−06 | 3.4114E−08 | −5.5780E−11 | 2.2166E−11 |
| S4 | −1.7510E−02 | 4.6811E−03 | −2.0722E−03 | 8.3901E−04 | −2.8889E−04 | 7.0070E−05 | −1.0908E−05 | 9.6125E−07 | −3.6479E−08 |
| S5 | 2.0843E−03 | 6.0969E−03 | −3.0395E−03 | 7.5703E−04 | −9.8319E−05 | 7.0154E−06 | −3.2065E−07 | 1.6285E−08 | −1.0409E−09 |
| S6 | −6.0892E−02 | 1.6379E−02 | 3.2453E−04 | −1.7240E−03 | 5.8372E−04 | −8.5639E−05 | 4.5224E−06 | 3.7865E−08 | 0.0000E+00 |
| S7 | 2.7342E−04 | −9.8443E−03 | 3.7864E−04 | 1.1102E−03 | −2.4538E−04 | 2.1941E−06 | 1.5788E−06 | 1.3412E−07 | 0.0000E+00 |
| S8 | 8.9914E−02 | −3.1969E−02 | −7.2733E−03 | 7.7723E−03 | −2.3699E−03 | 3.2337E−04 | −1.4865E−05 | −8.9853E−08 | −2.5994E−08 |
| S9 | −5.3305E−02 | 1.2388E−02 | −2.2815E−03 | −2.7588E−03 | 1.7946E−03 | −3.7699E−04 | 2.1735E−05 | 8.4914E−07 | 8.1684E−10 |
| S10 | −9.9136E−02 | 4.0105E−02 | −2.0426E−02 | 6.2514E−03 | −4.1326E−04 | −4.3486E−04 | 1.7381E−04 | −2.2779E−05 | 0.0000E+00 |
| S11 | −2.2426E−02 | −1.2890E−03 | −2.5531E−03 | 1.4135E−03 | −7.9926E−04 | 2.1792E−04 | −1.7138E−05 | −2.0121E−07 | −3.2140E−08 |
| S12 | −3.3264E−02 | 8.8672E−03 | −6.7557E−03 | 2.9381E−03 | −9.0464E−04 | 1.6814E−04 | −1.1800E−05 | −1.4099E−08 | −2.4558E−08 |
| S13 | −6.9077E−02 | −1.5093E−02 | 1.2533E−02 | −3.9785E−03 | 6.8381E−04 | −5.5319E−05 | 1.4116E−06 | 5.8440E−09 | 1.1043E−09 |
| S14 | −5.8063E−02 | −8.2575E−03 | 8.7559E−03 | −3.2731E−03 | 6.1252E−04 | −5.3488E−05 | 1.5710E−06 | 1.0517E−08 | 7.3223E−10 |
| S15 | −5.7433E−02 | 3.2504E−02 | −1.2430E−02 | 2.5058E−03 | −2.6284E−04 | 1.3604E−05 | −2.5004E−07 | −1.4012E−09 | −6.7699E−11 |
| S16 | −6.5914E−02 | 2.6093E−02 | −8.1130E−03 | 1.5621E−03 | −1.7443E−04 | 9.8446E−06 | −1.9046E−07 | 1.3952E−09 | −1.7426E−10 |

FIG. 6A shows a longitudinal aberration curve of the optical imaging system according to Embodiment 3 to represent deviation of a convergence focal point after light with different wavelengths passes through the system. FIG. 6B shows an astigmatism curve of the optical imaging system according to Embodiment 3 to represent a curvature of tangential image surface and a curvature of sagittal image surface. FIG. 6C shows a distortion curve of the optical imaging system according to Embodiment 3 to represent distortion values corresponding to different fields of view. FIG. 6D shows a lateral color curve of the optical imaging system according to Embodiment 3 to represent deviation of different image heights on the imaging surface after the light passes through the system. According to FIGS. 6A-6D, it can be seen that the optical imaging system provided in Embodiment 3 may achieve high imaging quality.

### Embodiment 4

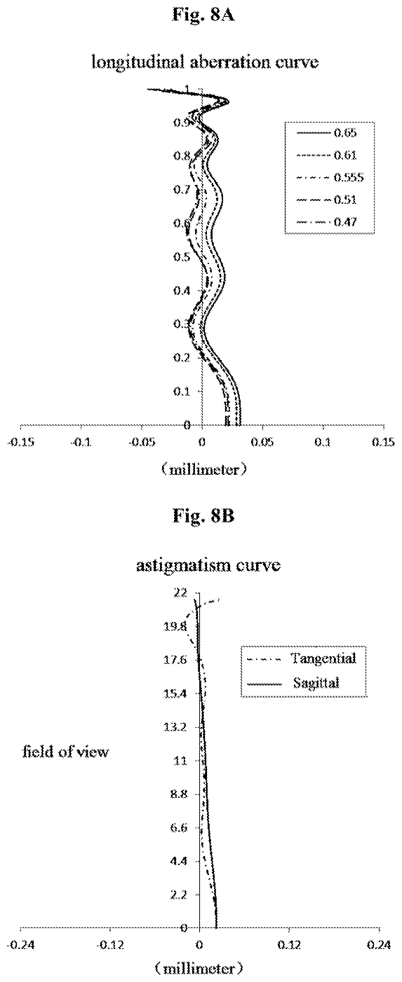

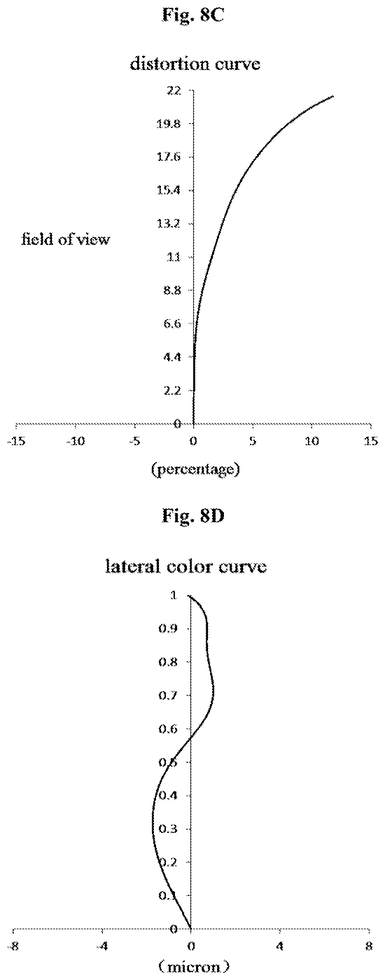

An optical imaging system according to Embodiment 4 of the disclosure will be described below with reference to FIGS. 7-8D. FIG. 7 shows a structural schematic diagram of an optical imaging system according to Embodiment 4 of the disclosure.

As shown in FIG. 7, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 4, a value of a total effective focal length f of the optical imaging system is 7.80 mm, a value of an on-axis distance TTL from the object-side surface S1 of the first lens E1 to the imaging surface S19 is 8.90 mm, ImgH is a half of a diagonal length of an effective pixel region on the imaging surface S19, and a value of ImgH is 3.43 mm, Semi-FOV is a half of a maximum field of view, and a value of Semi-FOV is 21.59°, and a value of the Fno of the optical imaging system is 1.15.

Table 7 shows a basic parameter table of the optical imaging system of Embodiment 4, wherein the units of the curvature radius, the thickness/distance and the focal length are all millimeters (mm). Table 8 shows high-order coefficients A4, A6, A8, A10, Al2, A14, A16, A18, A20, and A22 applied to each of the aspheric mirror surfaces S1 to S16 in Embodiment 4. A surface type of each aspheric surface may be defined by formula (1) given in Embodiment 1.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.7724 | 1.9500 | 1.54 | 55.80 | 6.66 | 0.0000 |
| S2 | Aspheric | −55.7183 | 0.0343 | | | | 0.0000 |
| S3 | Aspheric | 4.4658 | 0.3400 | 1.68 | 19.25 | −11.03 | 0.0000 |
| S4 | Aspheric | 2.7093 | 0.2084 | | | | 0.0000 |
| S5 | Aspheric | 4.6222 | 1.3083 | 1.54 | 55.80 | 227.31 | 0.0000 |
| S6 | Aspheric | 4.3292 | 0.0450 | | | | 0.0000 |
| S7 | Aspheric | 3.4959 | 0.5319 | 1.54 | 55.80 | 15.12 | 0.0000 |
| S8 | Aspheric | 5.8138 | 0.1085 | | | | 0.0000 |
| S9 | Aspheric | 2.3921 | 0.3000 | 1.68 | 19.25 | −22.29 | 0.0000 |
| S10 | Aspheric | 1.9605 | 1.1126 | | | | 0.0000 |
| S11 | Aspheric | 15.4095 | 0.5625 | 1.68 | 19.25 | 33.76 | 0.0000 |
| S12 | Aspheric | 46.5080 | 0.5141 | | | | 0.0000 |
| S13 | Aspheric | 4.6606 | 0.3029 | 1.54 | 55.80 | −104.84 | 0.0000 |
| S14 | Aspheric | 4.2064 | 0.2428 | | | | 0.0000 |
| S15 | Aspheric | 30.3732 | 0.4530 | 1.68 | 19.25 | −13.42 | 0.0000 |
| S16 | Aspheric | 6.9575 | 0.1338 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 8

| Surface | | | | | |
|---|---|---|---|---|---|
| number | A4 | A6 | A8 | A10 | A12 |
| S1 | −1.5746E−01 | −3.4628E−01 | 1.2369E+00 | −5.1970E+00 | 1.6355E+01 |
| S2 | 2.9124E−01 | 2.0911E+00 | −6.0559E+00 | 5.9727E+00 | −1.5013E+00 |
| S3 | −9.2987E−01 | 1.1702E+00 | 2.1698E+00 | −1.0083E+01 | 1.3545E+01 |
| S4 | −6.0841E−01 | −1.5308E+00 | 2.4266E+01 | −1.5759E+02 | 5.8497E+02 |
| S5 | 1.7825E−02 | 1.8029E+00 | −5.1011E+00 | 7.3390E+00 | −5.0081E+00 |
| S6 | −2.2043E+00 | 4.4939E+00 | −4.6171E+00 | −6.9129E−01 | 9.0210E+00 |
| S7 | −1.0740E−01 | −8.3247E−01 | −1.6371E+00 | 8.4920E+00 | −1.0186E+01 |
| S8 | 1.9200E+00 | −3.2685E+00 | −2.8729E+00 | 1.5546E+01 | −2.2167E+01 |
| S9 | −6.8457E−01 | 8.4859E−01 | −1.3683E+00 | 1.5186E−01 | 2.0630E+00 |
| S10 | −7.6756E−01 | 1.0265E+00 | −1.6376E+00 | 1.8032E+00 | −1.1409E+00 |
| S11 | −2.9979E−01 | −4.6008E−02 | −3.3542E−01 | 7.4906E−01 | −1.5179E+00 |
| S12 | −7.6230E−01 | 6.7652E−01 | −2.4924E+00 | 5.8169E+00 | −9.4462E+00 |
| S13 | −1.5884E+00 | −7.7351E+00 | 2.8456E+01 | −4.9756E+01 | 4.8685E+01 |
| S14 | −1.9116E+00 | −8.5688E+00 | 4.3118E+01 | −9.8539E+01 | 1.1776E+02 |
| S15 | −5.3361E+00 | 2.2879E+01 | −6.1314E+01 | 8.8871E+01 | −6.7899E+01 |
| S16 | −6.6617E+00 | 2.6277E+01 | −7.3517E+01 | 1.2168E+02 | −1.1370E+02 |
| Surface | | | | | |
| number | A14 | A16 | A18 | A20 | A22 |
| S1 | −3.8053E+01 | 5.6355E+01 | −5.1126E+01 | 2.6102E+01 | −5.7720E+00 |
| S2 | −1.1172E+00 | 5.9024E−01 | 0.0000E+00 | 0.0000E+00 | 0.0000E+00 |
| S3 | −7.6113E+00 | 1.4647E+00 | −9.7626E−02 | 9.6252E−02 | 0.0000E+00 |
| S4 | −1.3422E+03 | 1.9336E+03 | −1.7056E+03 | 8.4256E+02 | −1.7882E+02 |
| S5 | 1.2949E+00 | 1.3754E−01 | −2.9964E−01 | 1.5757E−01 | −4.4892E−02 |
| S6 | −1.0149E+01 | 3.5748E+00 | 1.1845E−01 | 0.0000E+00 | 0.0000E+00 |
| S7 | 3.5872E+00 | 3.7257E−01 | 8.9714E−03 | 2.3724E−02 | 0.0000E+00 |
| S8 | 1.3981E+01 | −2.7645E+00 | −3.7941E−01 | 2.9302E−02 | −3.0895E−02 |
| S9 | −2.0238E+00 | 4.7282E−01 | 5.8270E−02 | −2.2765E−03 | 0.0000E+00 |
| S10 | 2.6737E−01 | 1.3986E−01 | −8.3363E−02 | 0.0000E+00 | 0.0000E+00 |
| S11 | 1.3955E+00 | −3.7402E−01 | −1.6810E−02 | −6.2325E−03 | 0.0000E+00 |
| S12 | 8.6748E+00 | −2.8818E+00 | −6.0887E−02 | −1.0615E−01 | 0.0000E+00 |
| S13 | −2.3251E+01 | 3.4157E+00 | 3.9018E−01 | −1.9841E−02 | 2.9552E−02 |
| S14 | −6.7225E+01 | 1.2282E+01 | 1.4445E+00 | −6.0039E−02 | 1.0502E−01 |
| S15 | 2.5348E+01 | −3.1171E+00 | −2.6019E−01 | −3.7007E−03 | −1.3505E−02 |
| S16 | 5.2766E+01 | −6.8211E+00 | −1.7320E+00 | 4.4718E−01 | −2.1696E−01 |

FIG. 8A shows a longitudinal aberration curve of the optical imaging system according to Embodiment 4 to represent deviation of a convergence focal point after light with different wavelengths passes through the system. FIG. 8B shows an astigmatism curve of the optical imaging system according to Embodiment 4 to represent a curvature of tangential image surface and a curvature of sagittal image surface. FIG. 8C shows a distortion curve of the optical imaging system according to Embodiment 4 to represent distortion values corresponding to different fields of view. FIG. 8D shows a lateral color curve of the optical imaging system according to Embodiment 4 to represent deviation of different image heights on the imaging surface after the light passes through the system. According to FIGS. 8A-8D, it can be seen that the optical imaging system provided in Embodiment 4 may achieve high imaging quality.

### Embodiment 5

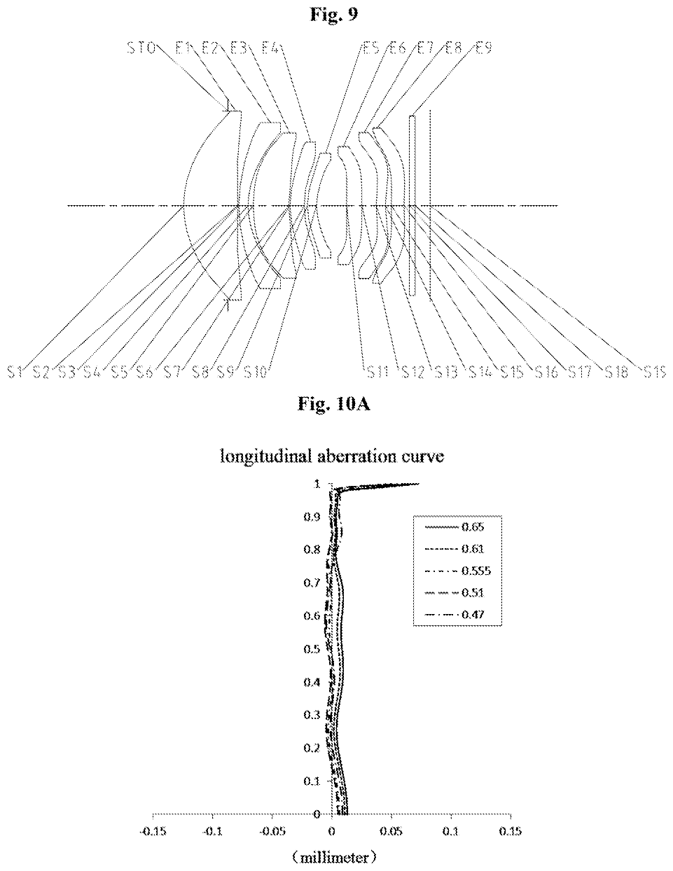

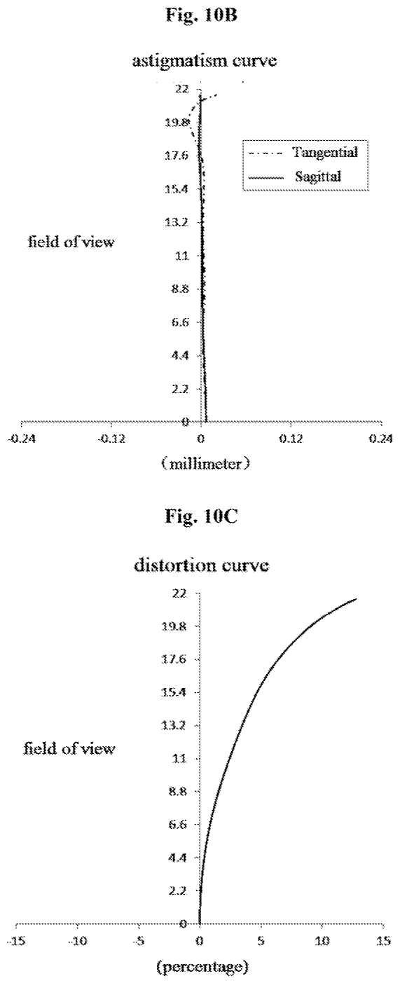

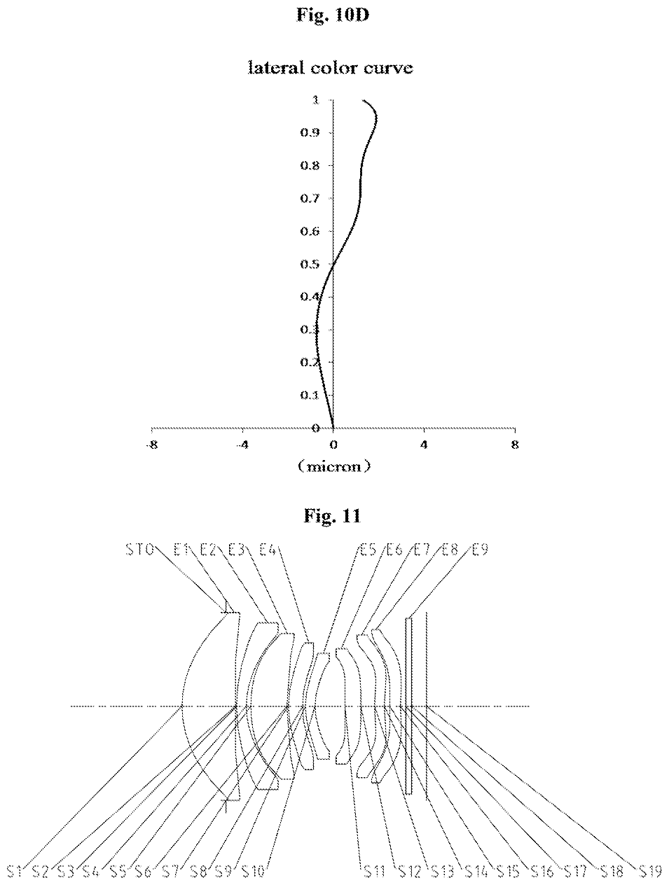

An optical imaging system according to Embodiment 5 of the disclosure will be described below with reference to FIGS. 9-10D. FIG. 9 shows a structural schematic diagram of an optical imaging system according to Embodiment 5 of the disclosure.

As shown in FIG. 9, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 5, a value of a total effective focal length f of the optical imaging system is 7.70 mm, a value of an on-axis distance TTL from the object-side surface S1 of the first lens E1 to the imaging surface S19 is 8.90 mm, ImgH is a half of a diagonal length of an effective pixel region on the imaging surface S19, and a value of ImgH is 3.43 mm, Semi-FOV is a half of a maximum field of view a value of Semi-FOV is 21.60°, and a value of the Fno of the optical imaging system is 1.12.

Table 9 shows a basic parameter table of the optical imaging system of Embodiment 5, wherein the units of the curvature radius, the thickness/distance and the focal length are all millimeters (mm). Table 10 shows high-order coefficients applied to each aspheric mirror surface in Embodiment 5. A surface type of each aspheric surface may be defined by formula (1) given in Embodiment 1.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.7679 | 1.9500 | 1.54 | 55.80 | 6.41 | 0.0000 |
| S2 | Aspheric | −32.6411 | 0.0365 | | | | 0.0000 |
| S3 | Aspheric | 4.8567 | 0.3400 | 1.68 | 19.25 | −10.31 | 0.0000 |
| S4 | Aspheric | 2.7840 | 0.1805 | | | | 0.0000 |
| S5 | Aspheric | 4.7318 | 1.2914 | 1.54 | 55.80 | 819.52 | 0.0000 |
| S6 | Aspheric | 4.3273 | 0.0450 | | | | 0.0000 |
| S7 | Aspheric | 3.5412 | 0.5154 | 1.54 | 55.80 | 15.27 | 0.0000 |
| S8 | Aspheric | 5.9175 | 0.1082 | | | | 0.0000 |
| S9 | Aspheric | 2.4209 | 0.3300 | 1.68 | 19.25 | −24.51 | 0.0000 |
| S10 | Aspheric | 1.9965 | 1.0894 | | | | 0.0000 |
| S11 | Aspheric | 15.9486 | 0.5500 | 1.68 | 19.25 | 37.43 | 0.0000 |
| S12 | Aspheric | 42.3789 | 0.5194 | | | | 0.0000 |
| S13 | Aspheric | 4.4374 | 0.3300 | 1.54 | 55.80 | −35.67 | 0.0000 |
| S14 | Aspheric | 3.5090 | 0.2181 | | | | 0.0000 |
| S15 | Aspheric | 13.1210 | 0.4566 | 1.68 | 19.25 | −27.89 | 0.0000 |
| S16 | Aspheric | 7.6351 | 0.1877 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 10

| Surface | | | | | |
|---|---|---|---|---|---|
| number | A4 | A6 | A8 | A10 | A12 |
| S1 | −1.5222E−01 | −1.5402E−01 | 2.5463E−01 | −1.8626E+00 | 7.6181E+00 |
| S2 | 5.1052E−01 | 1.1169E+00 | −3.7648E+00 | 3.1183E+00 | 3.0892E−01 |
| S3 | −1.0515E+00 | 1.7230E+00 | 6.3642E−01 | −7.3961E+00 | 1.0912E+01 |
| S4 | −8.3679E−01 | 8.1927E−01 | 1.7597E+00 | −2.2913E+01 | 9.5088E+01 |
| S5 | 1.1239E−02 | 1.8337E+00 | −5.2241E+00 | 7.4443E+00 | −5.0961E+00 |
| S6 | −2.5033E+00 | 6.2028E+00 | −1.0235E+01 | 1.0341E+01 | −3.8030E+00 |
| S7 | −2.8614E−01 | 4.3543E−01 | −5.5998E+00 | 1.5893E+01 | −1.8675E+01 |
| S8 | 1.8727E+00 | −3.1791E+00 | −2.8442E+00 | 1.5202E+01 | −2.1615E+01 |
| S9 | −6.3678E−01 | 7.1030E−01 | −1.2429E+00 | 3.8828E−01 | 1.4765E+00 |
| S10 | −6.9565E−01 | 8.7160E−01 | −1.3537E+00 | 1.4966E+00 | −9.6598E−01 |
| S11 | −2.9978E−01 | 1.1217E−01 | −7.2551E−01 | 1.2729E+00 | −1.7628E+00 |
| S12 | −7.5781E−01 | 1.1136E+00 | −3.7709E+00 | 7.6226E+00 | −1.0387E+01 |
| S13 | −2.4752E+00 | −1.7655E+00 | 1.2930E+01 | −2.9928E+01 | 3.5948E+01 |
| S14 | −3.0255E+00 | −6.6580E−01 | 1.4705E+01 | −4.4842E+01 | 6.2694E+01 |
| S15 | −3.6626E+00 | 1.1617E+01 | −2.9832E+01 | 4.1787E+01 | −2.9553E+01 |
| S16 | −4.3285E+00 | 1.2391E+01 | −3.1499E+01 | 4.9811E+01 | −4.4413E+01 |
| Surface | | | | | |
| number | A14 | A16 | A18 | A20 | A22 |
| S1 | −2.0210E+01 | 3.1028E+01 | −2.8390E+01 | 1.4581E+01 | −3.2557E+00 |
| S2 | −1.5707E+00 | 5.8077E−01 | 0.0000E+00 | 0.0000E+00 | 0.0000E+00 |
| S3 | −6.3353E+00 | 1.1807E+00 | 8.7776E−03 | 4.5557E−02 | 0.0000E+00 |
| S4 | −2.2699E+02 | 3.3324E+02 | −2.9817E+02 | 1.4956E+02 | −3.2355E+01 |
| S5 | 1.4913E+00 | −2.3722E−01 | 7.3659E−02 | −2.8084E−02 | 0.0000E+00 |
| S6 | −2.1160E+00 | 1.5792E+00 | 4.2735E−02 | 0.0000E+00 | 0.0000E+00 |
| S7 | 8.9272E+00 | −9.2940E−01 | −3.1214E−02 | −1.5718E−02 | 0.0000E+00 |
| S8 | 1.3651E+01 | −2.7405E+00 | −34726E−01 | 1.9523E−02 | −2.6141E−02 |
| S9 | −1.5911E+00 | 3.8334E−01 | 4.5368E−02 | 2.2998E−03 | 0.0000E+00 |
| S10 | 2.7188E−01 | 7.5855E−02 | −5.6716E−02 | 0.0000E+00 | 0.0000E+00 |
| S11 | 1.3275E+00 | −3.2257E−01 | −1.4776E−02 | −4.3159E−03 | 0.0000E+00 |
| S12 | 8.2747E+00 | −2.4769E+00 | −8.7516E−02 | −6.7641E−02 | 0.0000E+00 |
| S13 | −1.9753E+01 | 3.3367E+00 | 3.1767E−01 | 1.2825E−03 | 1.7921E−02 |
| S14 | −3.9380E+01 | 7.9314E+00 | 7.1883E−01 | 2.1333E−02 | 3.4913E−02 |
| S15 | 9.8243E+00 | −1.0766E+00 | −4.3322E−02 | −1.4646E−02 | 0.0000E+00 |
| S16 | 1.9257E+01 | −2.5237E+00 | 5.0134E−02 | −1.1106E−01 | 0.0000E+00 |

FIG. 10A shows a longitudinal aberration curve of the optical imaging system according to Embodiment 5 to represent deviation of a convergence focal point after light with different wavelengths passes through the system. FIG. 10B shows an astigmatism curve of the optical imaging system according to Embodiment 5 to represent a curvature of tangential image surface and a curvature of sagittal image surface. FIG. 10C shows a distortion curve of the optical imaging system according to Embodiment 5 to represent distortion values corresponding to different fields of view. FIG. 10D shows a lateral color curve of the optical imaging system according to Embodiment 5 to represent deviation of different image heights on the imaging surface after the light passes through the system. According to FIGS. 10A-10D, it can be seen that the optical imaging system provided in Embodiment 5 may achieve high imaging quality.

### Embodiment 6

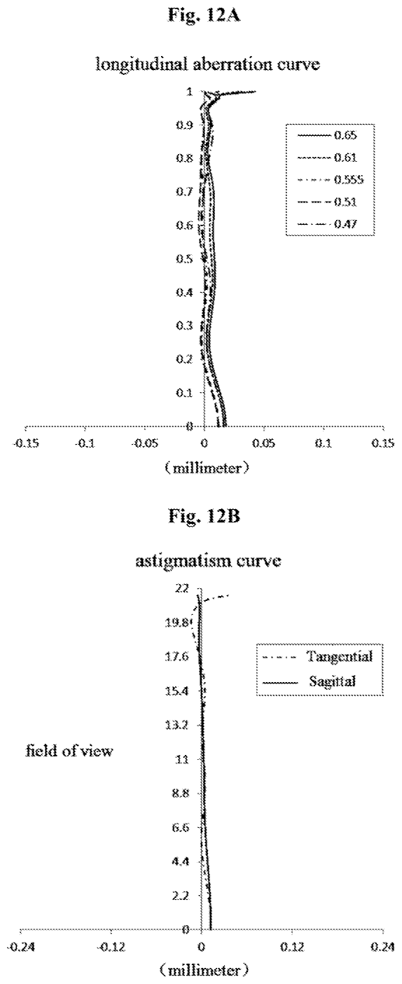

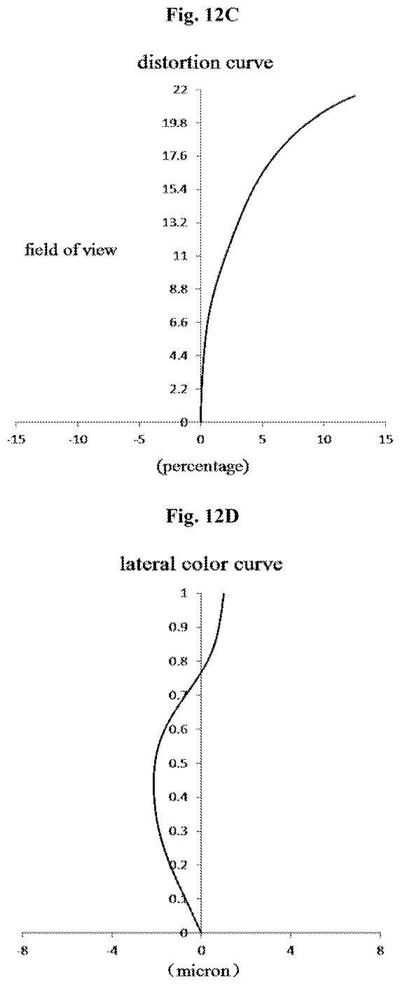

An optical imaging system according to Embodiment 6 of the disclosure will be described below with reference to FIGS. 11-12D. FIG. 11 shows a structural schematic diagram of an optical imaging system according to Embodiment 6 of the disclosure.

As shown in FIG. 11, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 6, a value of a total effective focal length f of the optical imaging system is 7.70 mm, a value of an on-axis distance TTL from the object-side surface S1 of the first lens E1 to the imaging surface S19 is 8.90 mm, ImgH is a half of a diagonal length of an effective pixel region on the imaging surface S19, and a value of ImgH is 3.43 mm, Semi-FOV is a half of a maximum field of view, and a value of Semi-FOV is 21.57°, and a value of the Fno of the optical imaging system is 1.12.

Table 11 shows a basic parameter table of the optical imaging system of Embodiment 6, wherein the units of the curvature radius, the thickness/distance and the focal length are all millimeters (mm). Table 12 shows high-order coefficients applied to each aspheric mirror surface in Embodiment 6. A surface type of each aspheric surface may be defined by formula (1) given in Embodiment 1.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.7668 | 1.9500 | 1.54 | 55.80 | 6.47 | 0.0000 |
| S2 | Aspheric | −36.6598 | 0.0300 | | | | 0.0000 |
| S3 | Aspheric | 5.0187 | 0.3600 | 1.68 | 19.25 | −10.59 | 0.0000 |
| S4 | Aspheric | 2.8681 | 0.1670 | | | | 0.0000 |
| S5 | Aspheric | 4.8391 | 1.3118 | 1.54 | 55.80 | −520.96 | 0.0000 |
| S6 | Aspheric | 4.3064 | 0.0492 | | | | 0.0000 |
| S7 | Aspheric | 3.3904 | 0.5244 | 1.54 | 55.80 | 13.29 | 0.0000 |
| S8 | Aspheric | 6.1136 | 0.0948 | | | | 0.0000 |
| S9 | Aspheric | 2.5515 | 0.3500 | 1.68 | 19.25 | −20.61 | 0.0000 |
| S10 | Aspheric | 2.0378 | 1.0958 | | | | 0.0000 |
| S11 | Aspheric | 21.3868 | 0.5779 | 1.68 | 19.25 | 42.16 | 0.0000 |
| S12 | Aspheric | 84.1366 | 0.4985 | | | | 0.0000 |
| S13 | Aspheric | 5.7498 | 0.3539 | 1.54 | 55.80 | −327.35 | 0.0000 |
| S14 | Aspheric | 5.4479 | 0.1985 | | | | 0.0000 |
| S15 | Aspheric | 9.6319 | 0.3875 | 1.68 | 19.25 | −14.33 | 0.0000 |
| S16 | Aspheric | 4.7573 | 0.1990 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 12

| Surface | | | | | |
|---|---|---|---|---|---|
| number | A4 | A6 | A8 | A10 | A12 |
| S1 | −1.4531E−01 | −1.8762E−01 | 4.1659E−01 | −2.4267E+00 | 9.5323E+00 |
| S2 | 5.0876E−01 | 9.7075E−01 | −2.7406E+00 | 3.9846E−01 | 3.8032E+00 |
| S3 | −1.0169E+00 | 1.4453E+00 | 1.5328E+00 | −8.7800E+00 | 1.2148E+01 |
| S4 | −7.9354E−01 | 9.4119E−01 | −1.1432E+00 | −4.6551E+00 | 2.9581E+01 |
| S5 | 1.0418E−01 | 1.7128E+00 | −5.4468E+00 | 8.4166E+00 | −6.5494E+00 |
| S6 | −2.6253E+00 | 6.5910E+00 | −1.0839E+01 | 1.0545E+01 | −3.3817E+00 |
| S7 | −4.9156E−01 | 9.3459E−01 | −5.5618E+00 | 1.3395E+01 | −1.3949E+01 |
| S8 | 1.7403E+00 | −2.8822E+00 | −2.4705E+00 | 1.2889E+01 | −1.7778E+01 |
| S9 | −5.6459E−01 | 5.7956E−01 | −1.2193E+00 | 7.0029E−01 | 9.5569E−01 |
| S10 | −6.3876E−01 | 8.1728E−01 | −1.3870E+00 | 1.7968E+00 | −1.4974E+00 |
| S11 | −2.7741E−01 | 1.2662E−02 | −3.4339E−01 | 5.9857E−01 | −1.0160E+00 |
| S12 | −6.8238E−01 | 4.8798E−01 | −1.7259E+00 | 4.0813E+00 | −6.7051E+00 |
| S13 | −6.5253E−01 | −1.0181E+01 | 3.4600E+01 | −6.4023E+01 | 6.8205E+01 |
| S14 | −2.8648E−01 | −1.3811E+01 | 5.2056E+01 | −1.0289E+02 | 1.1112E+02 |
| S15 | −5.7882E+00 | 2.0111E+01 | −4.6426E+01 | 6.1366E+01 | −4.4077E+01 |
| S16 | −7.3523E+00 | 2.6154E+01 | −6.6462E+01 | 1.0218E+02 | −9.0174E+01 |
| Surface | | | | | |
| number | A14 | A16 | A18 | A20 | A22 |
| S1 | −2.5047E+01 | 3.8466E+01 | −3.5184E+01 | 1.8042E+01 | −4.0230E+00 |
| S2 | −3.7514E+00 | 1.1081E+00 | 4.1186E−03 | 0.0000E+00 | 0.0000E+00 |
| S3 | −6.9511E+00 | 1.2983E+00 | 1.5530E−02 | 4.7487E−02 | 0.0000E+00 |
| S4 | −7.8344E+01 | 1.1856E+02 | −1.0730E+02 | 5.4347E+01 | −1.1922E+01 |
| S5 | 2.2667E+00 | 2.5679E−02 | −3.8000E−01 | 1.8987E−01 | −5.7618E−02 |
| S6 | −2.5129E+00 | 1.6578E+00 | 4.2034E−02 | 0.0000E+00 | 0.0000E+00 |
| S7 | 5.4660E+00 | −1.2870E−01 | −5.6127E−03 | 7.3129E−03 | 0.0000E+00 |
| S8 | 1.0910E+01 | −2.1623E+00 | −2.3146E−01 | 3.7833E−03 | −1.4372E−02 |
| S9 | −1.2308E+00 | 2.9121E−01 | 4.5594E−02 | 0.0000E+00 | 0.0000E+00 |
| S10 | 7.6913E−01 | −2.2676E−01 | 7.2545E−02 | −2.6865E−02 | 0.0000E+00 |
| S11 | 8.3696E−01 | −2.0154E−01 | −7.7313E−03 | −4.4844E−03 | 0.0000E+00 |
| S12 | 5.9860E+00 | −1.8941E+00 | −1.4535E−02 | −8.1365E−02 | 0.0000E+00 |
| S13 | −3.5974E+01 | 6.1523E+00 | 6.4926E−01 | −1.1708E−02 | 4.2419E−02 |
| S14 | −5.8619E+01 | 9.9046E+00 | 1.1809E+00 | −6.0087E−02 | 8.8474E−02 |
| S15 | 1.5978E+01 | −2.0941E+00 | −9.0213E−02 | −2.8024E−02 | 0.0000E+00 |
| S16 | 4.0532E+01 | −6.2851E+00 | −1.7912E−02 | −2.4289E−01 | 0.0000E+00 |

FIG. 12A shows a longitudinal aberration curve of the optical imaging system according to Embodiment 6 to represent deviation of a convergence focal point after light with different wavelengths passes through the system. FIG. 12B shows an astigmatism curve of the optical imaging system according to Embodiment 6 to represent a curvature of tangential image surface and a curvature of sagittal image surface. FIG. 12C shows a distortion curve of the optical imaging system according to Embodiment 6 to represent distortion values corresponding to different fields of view. FIG. 12D shows a lateral color curve of the optical imaging system according to Embodiment 6 to represent deviation of different image heights on the imaging surface after the light passes through the system. According to FIGS. 12A-12D, it can be seen that the optical imaging system provided in Embodiment 6 may achieve high imaging quality.

### Embodiment 7

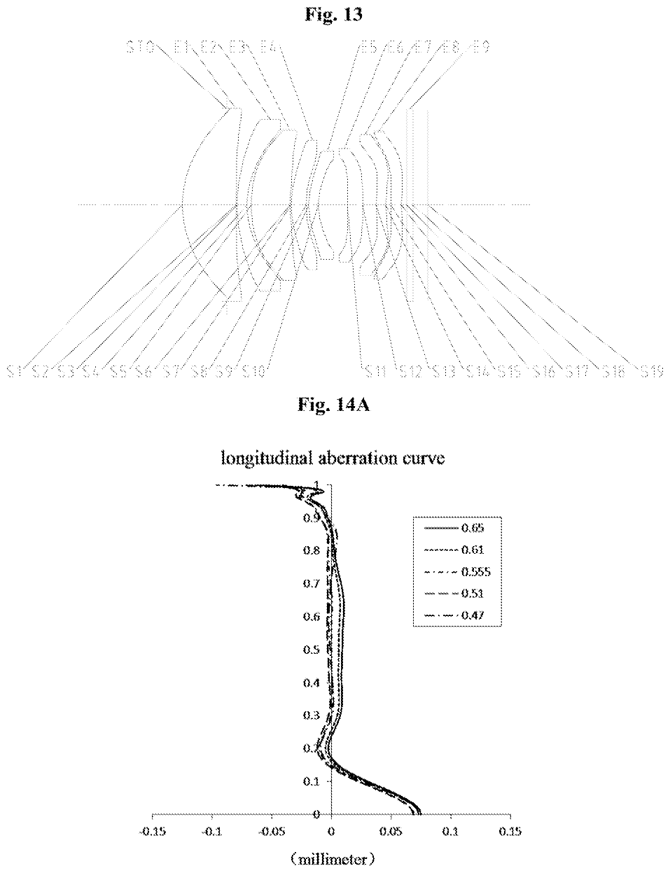

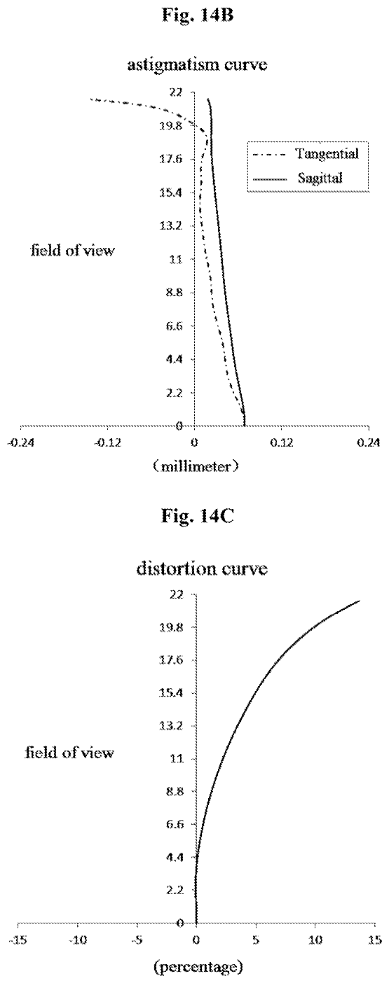

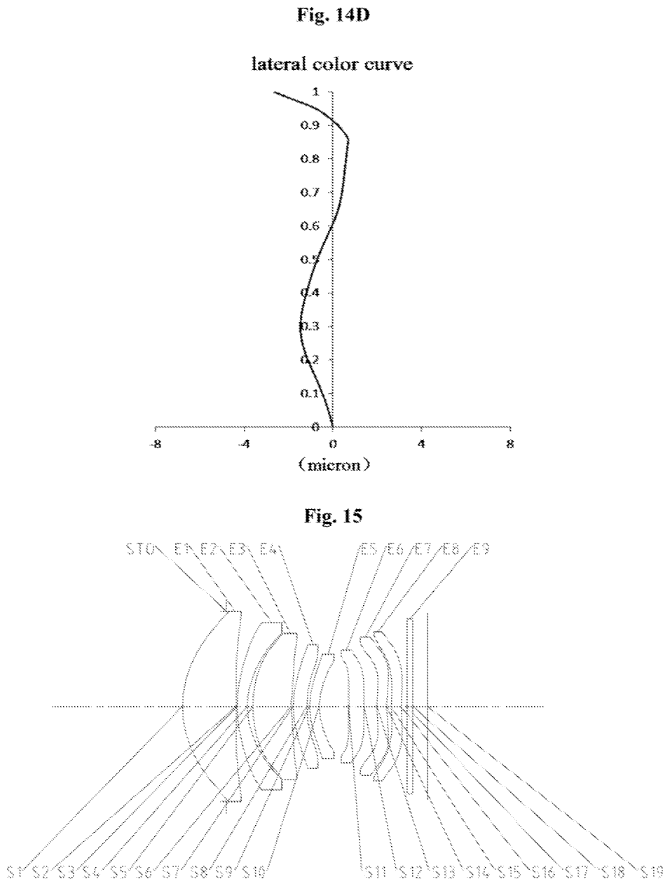

An optical imaging system according to Embodiment 7 of the disclosure will be described below with reference to FIGS. 13-14D. FIG. 13 shows a structural schematic diagram of an optical imaging system according to Embodiment 7 of the disclosure.

As shown in FIG. 13, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 7, a value of a total effective focal length f of the optical imaging system is 7.70 mm, a value of an on-axis distance TTL from the object-side surface S1 of the first lens E1 to the imaging surface S19 is 8.90 mm, ImgH is a half of a diagonal length of an effective pixel region on the imaging surface S19, and a value of ImgH is 3.43mm, Semi-FOV is a half of a maximum field of view, and a value of Semi-FOV is 21.55°, and a value of the Fno of the optical imaging system is 1.10.

Table 13 shows a basic parameter table of the optical imaging system of Embodiment 7, wherein the units of the curvature radius, the thickness/distance and the focal length are all millimeters (mm). Table 14 shows high-order coefficients A4, A6, A8, A10, Al2, A14, A16, A18, A20, A22, A24, A26, A28 and A30 applied to each of the aspheric mirror surfaces S1 to S16 in Embodiment 7. A surface type of each aspheric surface may be defined by formula (1) given in Embodiment 1.

TABLE 13

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.8439 | 1.9500 | 1.54 | 55.80 | 6.71 | 0.0000 |
| S2 | Aspheric | −47.1661 | 0.0300 | | | | 0.0000 |
| S3 | Aspheric | 4.9857 | 0.3600 | 1.68 | 19.25 | −10.68 | 0.0000 |
| S4 | Aspheric | 2.8660 | 0.1569 | | | | 0.0000 |
| S5 | Aspheric | 4.7065 | 1.4026 | 1.54 | 55.80 | 152.06 | 0.0000 |
| S6 | Aspheric | 4.4746 | 0.0450 | | | | 0.0000 |
| S7 | Aspheric | 3.4137 | 0.5422 | 1.54 | 55.80 | 13.27 | 0.0000 |
| S8 | Aspheric | 6.1919 | 0.0894 | | | | 0.0000 |
| S9 | Aspheric | 2.5688 | 0.3500 | 1.68 | 19.25 | −19.60 | 0.0000 |
| S10 | Aspheric | 2.0339 | 1.0614 | | | | 0.0000 |
| S11 | Aspheric | 21.8549 | 0.5500 | 1.68 | 19.25 | 37.54 | 0.0000 |
| S12 | Aspheric | 153.5783 | 0.4892 | | | | 0.0000 |
| S13 | Aspheric | 5.4384 | 0.3500 | 1.54 | 55.80 | −32.95 | 0.0000 |
| S14 | Aspheric | 4.0659 | 0.1823 | | | | 0.0000 |
| S15 | Aspheric | 5.2559 | 0.3795 | 1.68 | 19.25 | −24.43 | 0.0000 |
| S16 | Aspheric | 3.8728 | 0.2095 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 14

| Surface | | | | | | | |
|---|---|---|---|---|---|---|---|
| number | A4 | A6 | A8 | A10 | A12 | A14 | A16 |
| S1 | 3.3999E−02 | −4.5617E+00 | 5.8706E+01 | −4.9154E+02 | 2.7825E+03 | −1.1021E+04 | 3.1116E+04 |
| S2 | 7.7931E−01 | −4.3444E−01 | −4.8152E+00 | 1.1930E+02 | −1.0602E+03 | 5.2396E+03 | −1.6730E+04 |
| S3 | −8.4778E−01 | −5.1861E−01 | 9.7952E+00 | 3.8569E+00 | −3.0018E+02 | 1.6729E+03 | −5.1804E+03 |
| S4 | −1.0192E+00 | 4.2120E+00 | −3.6956E+01 | 2.3537E+02 | −9.9271E+02 | 2.7551E+03 | −4.8660E+03 |
| S5 | 1.1053E−01 | 2.0061E+00 | −6.7063E+00 | 1.0557E+01 | −5.9042E+00 | −1.2789E+01 | 5.8865E+01 |
| S6 | −2.4619E+00 | 9.6188E+00 | −4.3032E+01 | 1.8959E+02 | −5.5293E+02 | 5.7950E+02 | 2.4071E+03 |
| S7 | −5.1396E−01 | 1.4025E+00 | −1.2234E+01 | 5.1298E+01 | −1.4002E+02 | 2.5411E+02 | −1.3235E+02 |
| S8 | 1.7540E+00 | −2.9687E+00 | −2.6434E+00 | 1.4004E+01 | −2.0434E+01 | 1.7297E+01 | −2.1156E+01 |
| S9 | −5.9254E−01 | −8.2620E−01 | 2.4357E+01 | −2.4505E+02 | 1.4972E+03 | −6.1944E+03 | 1.8036E+04 |
| S10 | −7.2317E−01 | 1.1913E+00 | −5.6514E+00 | 4.5593E+01 | −2.9907E+02 | 1.3481E+03 | −4.2020E+03 |
| S11 | −2.2948E−01 | −2.9089E−01 | 2.9147E+00 | −2.1133E+01 | 9.4479E+01 | −2.8471E+02 | 5.9488E+02 |
| S12 | −6.2762E−01 | 1.8587E+00 | −2.1087E+01 | 1.6243E+02 | −8.6209E+02 | 3.2224E+03 | −8.6356E+03 |
| S13 | −1.4324E+00 | −8.7245E+00 | 1.6306E+02 | −1.9417E+03 | 1.3674E+04 | −6.2209E+04 | 1.9350E+05 |
| S14 | −3.8311E+00 | 1.9332E+01 | 4.1407E+00 | −1.3053E+03 | 1.0759E+04 | −4.6891E+04 | 1.3124E+05 |
| S15 | −8.1918E+00 | 3.5010E+01 | 4.9587E+01 | −1.9387E+03 | 1.3587E+04 | −5.3573E+04 | 1.3795E+05 |
| S16 | −8.8064E+00 | 4.6558E+01 | −2.1597E+02 | 6.9969E+02 | −1.5425E+03 | 2.7672E+03 | −6.3223E+03 |
| Surface | | | | | | | |
| number | A18 | A20 | A22 | A24 | A26 | A28 | A30 |
| S1 | −6.3218E+04 | 9.2472E+04 | −9.6377E+04 | 6.9752E+04 | −3.3288E+04 | 9.4140E+03 | −1.1944E+03 |
| S2 | 3.6758E+04 | −5.7034E+04 | 6.2705E+04 | −4.7983E+04 | 2.4379E+04 | −7.4086E+03 | 1.0205E+03 |
| S3 | 1.0505E+04 | −1.4602E+04 | 1.4024E+04 | −9.1502E+03 | .8691E+03 | −9.5492E+02 | 1.0422E+02 |
| S4 | 4.6049E+03 | 3.6498E+02 | −7.4294E+03 | 1.0421E+04 | −7.4419E+03 | 2.8455E+03 | −4.6404E+02 |
| S5 | −1.5385E+02 | 2.8537E+02 | −3.7557E+02 | 3.4117E+02 | −2.0253E+02 | 7.0140E+01 | −1.0596E+01 |
| S6 | −1.2698E+04 | 2.9974E+04 | −4.3569E+04 | 4.1067E+04 | −2.4565E+04 | 8.5035E+03 | −1.3000E+03 |
| S7 | −8.1343E+02 | 2.7739E+03 | −4.5598E+03 | 4.5053E+03 | −2.7123E+03 | 9.1839E+02 | −1.3416E+02 |
| S8 | 4.8568E+01 | −9.2487E+01 | 1.2587E+02 | −1.1992E+02 | 7.5810E+01 | −2.8539E+01 | 4.8353E+00 |
| S9 | −3.7575E+04 | 5.6208E+04 | −5.9836E+04 | 4.4201E+04 | −2.1517E+04 | 6.2026E+03 | −8.0150E+02 |
| S10 | 9.2210E+03 | −1.4353E+04 | 1.5753E+04 | −1.1912E+04 | 5.9033E+03 | −1.7247E+03 | 2.2506E+02 |
| S11 | −8.7403E+02 | 9.0565E+02 | −6.5573E+02 | 3.2356E+02 | −1.0332E+02 | 1.9161E+01 | −1.5556E+00 |
| S12 | 1.6718E+04 | −2.3327E+04 | 2.3157E+04 | −1.5905E+04 | 7.1654E+03 | −1.9009E+03 | 2.2468E+02 |
| S13 | −4.2316E+05 | 6.5668E+05 | −7.1898E+05 | 5.4271E+05 | −2.6866E+05 | 7.8481E+04 | −1.0253E+04 |
| S14 | −2.5198E+05 | 3.4011E+05 | −3.2313E+05 | 2.1185E+05 | −9.1285E+04 | 2.3270E+04 | −2.6586E+03 |
| S15 | −2.4468E+05 | 3.0503E+05 | −2.6716E+05 | 1.6108E+05 | −6.3667E+04 | 1.4844E+04 | −1.5463E+03 |
| S16 | 1.7259E+04 | −3.6954E+04 | 5.3828E+04 | −5.1789E+04 | 3.1700E+04 | −1.1226E+04 | 1.7550E+03 |

FIG. 14A shows a longitudinal aberration curve of the optical imaging system according to Embodiment 7 to represent deviation of a convergence focal point after light with different wavelengths passes through the system. FIG. 14B shows an astigmatism curve of the optical imaging system according to Embodiment 7 to represent a curvature of tangential image surface and a curvature of sagittal image surface. FIG. 14C shows a distortion curve of the optical imaging system according to Embodiment 7 to represent distortion values corresponding to different fields of view. FIG. 14D shows a lateral color curve of the optical imaging system according to Embodiment 7 to represent deviation of different image heights on the imaging surface after the light passes through the system. According to FIGS. 14A-14D, it can be seen that the optical imaging system provided in Embodiment 7 may achieve high imaging quality.

### Embodiment 8

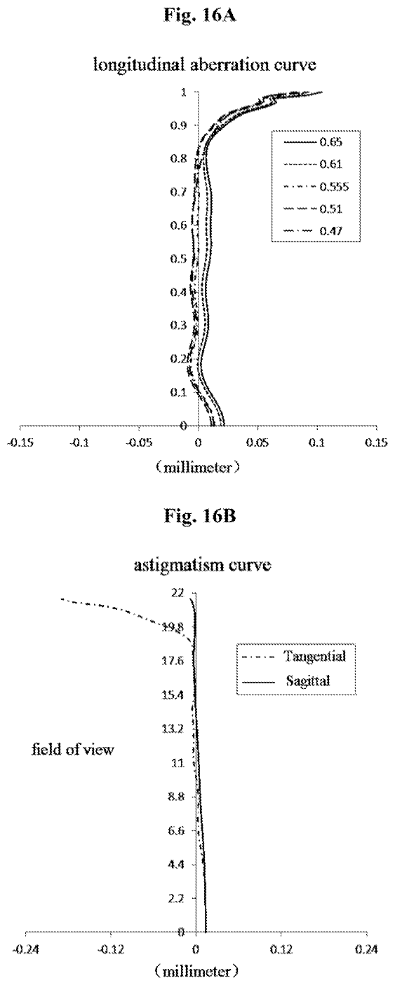

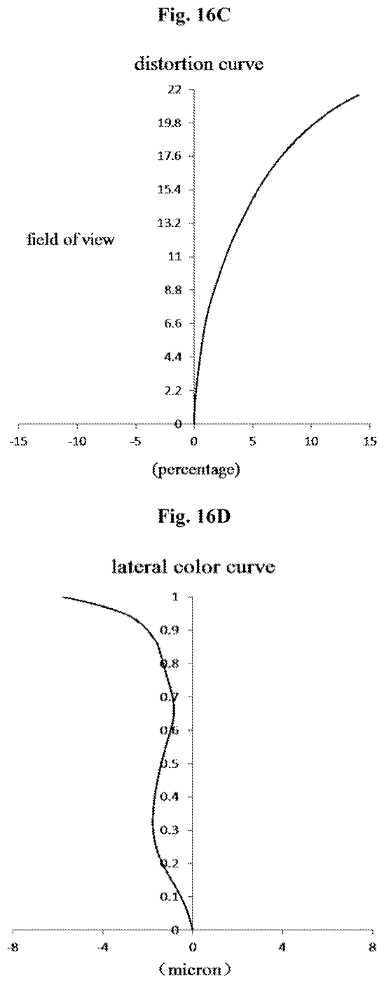

An optical imaging system according to Embodiment 8 of the disclosure will be described below with reference to FIGS. 15-16D. FIG. 15 shows a structural schematic diagram of an optical imaging system according to Embodiment 8 of the disclosure.

As shown in FIG. 15, the optical imaging system sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9.

The first lens E1 has a positive refractive power, an object-side surface S1 thereof is a convex surface, and an image-side surface S2 thereof is a convex surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The eighth lens E8 has a negative refractive power, an object-side surface S15 thereof is a convex surface, and an image-side surface S16 thereof is a concave surface. The optical filter E9 has an object-side surface S17 and an image-side surface S18. The optical imaging system has an imaging surface S19. Light from an object sequentially penetrates through each of the surfaces S1 to S18, and is finally imaged on the imaging surface S19.

In Embodiment 8, a value of a total effective focal length f of the optical imaging system is 7.54 mm, a value of an on-axis distance TTL from the object-side surface S1 of the first lens E1 to the imaging surface S19 is 8.90 mm, ImgH is a half of a diagonal length of an effective pixel region on the imaging surface S19, and a value of ImgH is 3.43 mm, Semi-FOV is a half of a maximum field of view, and a value of Semi-FOV is 21.62°, and a value of the Fno of the optical imaging system is 1.09.

Table 15 shows a basic parameter table of the optical imaging system of Embodiment 8, wherein the units of the curvature radius, the thickness/distance and the focal length are all millimeters (mm). Table 16 shows high-order coefficients applied to each aspheric mirror surface in Embodiment 8. A surface type of each aspheric surface may be defined by formula (1) given in Embodiment 1.

TABLE 15

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −1.6000 | | | | |
| S1 | Aspheric | 3.8536 | 1.9466 | 1.54 | 55.80 | 6.76 | 0.0000 |
| S2 | Aspheric | −51.7434 | 0.0358 | | | | 0.0000 |
| S3 | Aspheric | 4.5676 | 0.3675 | 1.68 | 19.25 | −10.98 | 0.0000 |
| S4 | Aspheric | 2.7383 | 0.2090 | | | | 0.0000 |
| S5 | Aspheric | 4.6760 | 1.3875 | 1.54 | 55.80 | 119.37 | 0.0000 |
| S6 | Aspheric | 4.5213 | 0.0708 | | | | 0.0000 |
| S7 | Aspheric | 3.3788 | 0.4995 | 1.54 | 55.80 | 13.42 | 0.0000 |
| S8 | Aspheric | 6.0334 | 0.0941 | | | | 0.0000 |
| S9 | Aspheric | 2.5444 | 0.3500 | 1.68 | 19.25 | −18.81 | 0.0000 |
| S10 | Aspheric | 2.0030 | 1.0730 | | | | 0.0000 |
| S11 | Aspheric | 17.7307 | 0.5575 | 1.68 | 19.25 | 36.60 | 0.0000 |
| S12 | Aspheric | 61.4358 | 0.4661 | | | | 0.0000 |
| S13 | Aspheric | 5.8566 | 0.3529 | 1.54 | 55.80 | −36.40 | 0.0000 |
| S14 | Aspheric | 4.4112 | 0.1695 | | | | 0.0000 |
| S15 | Aspheric | 4.8385 | 0.3559 | 1.68 | 19.25 | −28.55 | 0.0000 |
| S16 | Aspheric | 3.7555 | 0.2131 | | | | 0.0000 |
| S17 | Spherical | Infinite | 0.2100 | 1.52 | 64.17 | | |
| S18 | Spherical | Infinite | 0.5418 | | | | |
| S19 | Spherical | Infinite | | | | | |

TABLE 16

| Surface | | | | | | | |
|---|---|---|---|---|---|---|---|
| number | A4 | A6 | A8 | A10 | A12 | A14 | A16 |
| S1 | −7.3865E−02 | −1.6483E+00 | 1.8531E+01 | −1.3164E+02 | 6.0227E+02 | −1.8612E+03 | 3.9679E+03 |
| S2 | 5.0698E−01 | 2.2386E+00 | −3.1445E+01 | 2.9621E+02 | −1.8191E+03 | 7.3812E+03 | −2.0635E+04 |
| S3 | −1.0526E+00 | 3.3811E+00 | −3.1889E+01 | 2.8952E+02 | −1.6221E+03 | 5.9086E+03 | −1.4750E+04 |
| S4 | −9.0869E−01 | 2.3005E+00 | −1.0407E+01 | −3.2674E+00 | 5.0273E+02 | −3.9342E+03 | 1.6670E+04 |
| S5 | 5.8249E−02 | 1.9409E+00 | −6.1095E+00 | 9.4193E+00 | −6.4479E+00 | −4.9091E+00 | 3.3214E+01 |
| S6 | −1.9180E+00 | 5.3337E+00 | −7.1515E−01 | −1.2873E+02 | 1.0760E+03 | −5.1580E+03 | 1.6515E+04 |
| S7 | −3.9032E−01 | −5.3165E−01 | 1.3789E+01 | −1.4948E+02 | 8.7553E+02 | −3.3131E+03 | 8.7820E+03 |
| S8 | 1.7116E+00 | −2.8649E+00 | −2.6254E+00 | 1.4086E+01 | −2.4121E+01 | 3.8550E+01 | −9.5615E+01 |
| S9 | −5.7776E−01 | 5.1598E−01 | 3.8711E+00 | −5.7562E+01 | 3.6646E+02 | −1.4762E+03 | 4.0705E+03 |
| S10 | −6.3096E−01 | 7.4882E−01 | −8.3725E−01 | 8.7681E−01 | −1.4007E+01 | 1.0065E+02 | −3.7424E+02 |
| S11 | −2.4511E−01 | 2.6869E−01 | −3.2856E+00 | 1.8931E+01 | −7.1411E+01 | 1.8178E+02 | −3.2544E+02 |
| S12 | −5.9406E−01 | 1.6965E+00 | −2.3104E+01 | 1.9272E+02 | −1.0553E+03 | 3.9829E+03 | −1.0676E+04 |
| S13 | −1.1943E+00 | −6.5193E+00 | 9.7068E+01 | −1.2476E+03 | 9.3224E+03 | −4.3862E+04 | 1.3887E+05 |
| S14 | −4.1751E+00 | 3.2346E+01 | −1.6828E+02 | 3.1801E+01 | 3.9154E+03 | −2.2643E+04 | 7.0232E+04 |
| S15 | −9.4808E+00 | 5.7621E+01 | −1.6512E+02 | −5.9520E+02 | 7.7456E+03 | −3.5401E+04 | 9.6893E+04 |
| S16 | −8.8072E+00 | 3.5465E+01 | −1.4632E+01 | −1.0928E+03 | 8.2757E+03 | −3.3239E+04 | 8.5845E+04 |
| Surface | | | | | | | |
| number | A18 | A20 | A22 | A24 | A26 | 428 | A30 |
| S1 | −5.8727E+03 | 5.9646E+03 | −4.0055E+03 | 1.6254E+03 | −3.0061E+02 | −1.7566E+01 | 1.1822E+01 |
| S2 | 4.0820E+04 | −5.7740E+04 | 5.8140E+04 | −4.0759E+04 | 1.8933E+04 | −5.2442E+03 | 6.5635E+02 |
| S3 | 2.5914E+04 | −3.2308E+04 | 2.8390E+04 | −1.7161E+04 | 6.7757E+03 | −1.5687E+03 | 1.6088E+02 |
| S4 | −4.5516E+04 | 8.4585E+04 | −1.0853E+05 | 9.4921E+04 | −5.4148E+04 | 1.8189E+04 | −2.7324E+03 |
| S5 | −9.8541E+01 | 2.0197E+02 | −2.9018E+02 | 2.8647E+02 | −1.8513E+02 | 7.0433E+01 | −1.1920E+01 |
| S6 | −3.6940E+04 | 5.8587E+04 | −6.5668E+04 | 5.0884E+04 | −2.5937E+04 | 7.8247E+03 | −1.0584E+03 |
| S7 | −1.6824E+04 | 2.3441E+04 | −2.3511E+04 | 1.6515E+04 | −7.6965E+03 | 2.1329E+03 | −2.6539E+02 |
| S8 | 2.3675E+02 | −4.4524E+02 | 6.1057E+02 | −5.9347E+02 | 3.8702E+02 | −1.5185E+02 | 2.7109E+01 |
| S9 | −7.9104E+03 | 1.0941E+04 | −1.0711E+04 | 7.2486E+03 | −3.2233E+03 | 8.4648E+02 | −9.9366E+01 |
| S10 | 8.6445E+02 | −1.3244E+03 | 1.3705E+03 | −9.4651E+02 | 4.1673E+02 | −1.0524E+02 | 1.1506E+01 |
| S11 | 4.2040E+02 | −3.9632E+02 | 2.7143E+02 | −1.3154E+02 | 4.2555E+01 | −8.1737E+00 | 6.9630E−01 |
| S12 | 2.0595E+04 | −2.8607E+04 | 2.8276E+04 | −1.9351E+04 | 8.6938E+03 | −2.3022E+03 | 2.7186E+02 |
| S13 | −3.0583E+05 | 4.7431E+05 | −5.1604E+05 | 3.8539E+05 | −1.8812E+05 | 5.4046E+04 | −6.9291E+03 |
| S14 | −1.4161E+05 | 1.9649E+05 | −1.9023E+05 | 1.2684E+05 | −5.5729E+04 | 1.4578E+04 | −1.7266E+03 |
| S15 | −1.7694E+05 | 2.2368E+05 | −1.9702E+05 | 1.1887E+05 | −4.6868E+04 | 1.0879E+04 | −1.1269E+03 |
| S16 | −1.5080E+05 | 1.8253E+05 | −1.4979E+05 | 7.9028E+04 | −2.3529E+04 | 2.5216E+03 | 2.3112E+02 |

FIG. 16A shows a longitudinal aberration curve of the optical imaging system according to Embodiment 8 to represent deviation of a convergence focal point after light with different wavelengths passes through the system. FIG. 16B shows an astigmatism curve of the optical imaging system according to Embodiment 8 to represent a curvature of tangential image surface and a curvature of sagittal image surface. FIG. 16C shows a distortion curve of the optical imaging system according to Embodiment 8 to represent distortion values corresponding to different fields of view. FIG. 16D shows a lateral color curve of the optical imaging system according to Embodiment 8 to represent deviation of different image heights on the imaging surface after the light passes through the system. According to FIGS. 16A-16D, it can be seen that the optical imaging system provided in Embodiment 8 may achieve high imaging quality.

From the above, Embodiment 1 to Embodiment 8 satisfy a relationship shown in Table 17 respectively.

TABLE 17

| Conditional expression/ | | | | | | | | |
|---|---|---|---|---|---|---|---|---|
| Embodiment | 1 | 2 | 3 | 4 | 5 | 6 | 7 | 8 |
| DT81/DT11 | 0.87 | 0.83 | 0.76 | 0.80 | 0.79 | 0.79 | 0.75 | 0.75 |
| SAG41/SAG31 | 0.57 | 0.56 | 0.55 | 0.47 | 0.54 | 0.54 | 0.53 | 0.49 |
| R4/R3 | 0.55 | 0.55 | 0.61 | 0.61 | 0.57 | 0.57 | 0.57 | 0.60 |
| DT51/DT41 | 0.90 | 0.85 | 0.85 | 0.85 | 0.82 | 0.83 | 0.84 | 0.84 |
| \|R1/f1\| | 0.60 | 0.60 | 0.57 | 0.57 | 0.59 | 0.58 | 0.57 | 0.57 |
| (T56 + T67 + T78)/TTL | 0.24 | 0.22 | 0.22 | 0.21 | 0.21 | 0.20 | 0.19 | 0.19 |
| CT3/CT1 | 0.52 | 0.58 | 0.59 | 0.67 | 0.66 | 0.67 | 0.72 | 0.71 |
| CT5/CT4 | 0.80 | 0.67 | 0.65 | 0.56 | 0.64 | 0.67 | 0.65 | 0.70 |
| R13/f | 0.57 | 0.53 | 0.49 | 0.60 | 0.58 | 0.75 | 0.71 | 0.78 |
| TTL/f | 1.09 | 1.13 | 1.13 | 1.14 | 1.16 | 1.16 | 1.16 | 1.18 |
| \|R10/R9\| | 0.81 | 0.85 | 0.81 | 0.82 | 0.82 | 0.80 | 0.79 | 0.79 |

The disclosure also provides an imaging device, which is provided with an electronic photosensitive element for imaging. The electronic photosensitive element may be a Charge Coupled Device (CCD) or a Complementary Metal Oxide Semiconductor (CMOS). The imaging device may be an independent imaging device such as a digital camera, or may be an imaging module integrated into a mobile electronic device such as a mobile phone. The imaging device is provided with the abovementioned optical imaging system.

The above description is only description about the preferred embodiments of the disclosure and adopted technical principles. It is understood by those skilled in the art that the scope of protection involved in the disclosure is not limited to the technical solutions formed by specifically combining the technical characteristics and should also cover other technical solutions formed by freely combining the technical characteristics or equivalent characteristics thereof without departing from the concept of the disclosure, for example, technical solutions formed by mutually replacing the characteristics and (but not limited to) the technical characteristics with similar functions provided in the disclosure.

What is claimed is:

1. An optical imaging system, sequentially comprising from an object side to an image side along an optical axis:
a first lens with a refractive power;
a second lens with a negative refractive power, an image-side surface thereof is a concave surface;
a third lens with a refractive power;
a fourth lens with a refractive power;
a fifth lens with a refractive power, an object-side surface thereof is a convex surface;
a sixth lens with a refractive power;
a seventh lens with a refractive power, an object-side surface thereof is a convex surface; and
an eighth lens with a refractive power;
wherein Semi-FOV is a half of a maximum field of view of the optical imaging system, and Semi-FOV satisfies Semi-FOV<30°.

2. The optical imaging system according to claim 1, wherein an image-side surface of the first lens is a convex surface.

3. The optical imaging system according to claim 1, wherein a total effective focal length f of the optical imaging system and an Entrance Pupil Diameter (EPD) of the optical imaging system satisfy f/EPD≤1.3.

4. The optical imaging system according to claim 1, wherein a maximum effective radius DT11 of an object-side surface of the first lens and a maximum effective radius DT81 of an object-side surface of the eighth lens satisfy DT81DT11≤0.87.

5. The optical imaging system according to claim 1, wherein an on-axis distance SAG41 from an intersection point of an object-side surface of the fourth lens and the optical axis to an effective radius vertex of the object-side surface of the fourth lens and an on-axis distance SAG31 from an intersection point of an object-side surface of the third lens and the optical axis to an effective radius vertex of the object-side surface of the third lens satisfy 0.1<SAG41/SAG31<0.9.

6. The optical imaging system according to claim 1, wherein a curvature radius R3 of an object-side surface of the second lens and a curvature radius R4 of the image-side surface of the second lens satisfy 0.2<R4/R3<0.8.

7. The optical imaging system according to claim 1, wherein a maximum effective radius DT41 of an object-side surface of the fourth lens and a maximum effective radius DT51 of the object-side surface of the fifth lens satisfy DT51/DT41<1.

8. The optical imaging system according to claim 1, wherein a curvature radius R1 of an object-side surface of the first lens and an effective focal length f1 of the first lens satisfy |R1/f1|≤0.60.

9. The optical imaging system according to claim 1, wherein a spacing distance T56 between the fifth lens and the sixth lens on the optical axis, a spacing distance T67 between the sixth lens and the seventh lens on the optical axis, a spacing distance T78 between the seventh lens and the eighth lens on the optical axis, and a spacing distance TTL from an object-side surface of the first lens to an imaging surface of the optical imaging system on the optical axis satisfy 0<(T56+T67+T78)/TTL<0.4.

10. The optical imaging system according to claim 1, wherein a center thickness CT1 of the first lens on the optical axis and a center thickness CT3 of the third lens on the optical axis satisfy 0.2<CT3/CT1<1.0.

11. The optical imaging system according to claim 1, wherein a center thickness CT4 of the fourth lens on the optical axis and a center thickness CT5 of the fifth lens on the optical axis satisfy 0.3<CT5/CT4<1.0.

12. The optical imaging system according to claim 1, wherein a curvature radius R13 of the object-side surface of the seventh lens and a total effective focal length f of the optical imaging system satisfy 0.1<R13/f<1.0.

13. The optical imaging system according to claim 1, wherein a spacing distance TTL from an object-side surface of the first lens to an imaging surface of the optical imaging system on the optical axis and a total effective focal length f of the optical imaging system satisfy TTL/f1≤18.

14. The optical imaging system according to claim 1, wherein a curvature radius R9 of the object-side surface of the fifth lens and a curvature radius R10 of an image-side surface of the fifth lens satisfy 0.5<IR10/R91<1.

15. An optical imaging system, sequentially comprising from an object side to an image side along an optical axis:
a first lens with a refractive power, an image-side surface thereof is a convex surface;
a second lens with a refractive power, an image-side surface thereof is a concave surface;
a third lens with a refractive power;
a fourth lens with a refractive power;
a fifth lens with a refractive power;
a sixth lens with a refractive power;
a seventh lens with a refractive power, an object-side surface thereof is a convex surface; and
an eighth lens with a refractive power;
wherein a total effective focal length f of the optical imaging system and an Entrance Pupil Diameter (EPD) of the optical imaging system satisfy f/EPD≤1.3.

16. The optical imaging system according to claim 15, wherein an object-side surface of the fifth lens is a convex surface.

17. The optical imaging system according to claim 15, wherein a maximum effective radius DT11 of the object-side surface of the first lens and a maximum effective radius DT81 of an object-side surface of the eighth lens satisfy DT81/DT11≤0.87.

18. The optical imaging system according to claim 17, wherein Semi-FOV is a half of a maximum field of view of the optical imaging system satisfys Semi-FOV<30°.

19. The optical imaging system according to claim 15, wherein an on-axis distance SAG41 from an intersection point of an object-side surface of the fourth lens and the optical axis to an effective radius vertex of the object-side surface of the fourth lens and an on-axis distance SAG31 from an intersection point of an object-side surface of the third lens and the optical axis to an effective radius vertex of the object-side surface of the third lens satisfy 0.1<SAG41/SAG31<0.9.

20. The optical imaging system according to claim 15, wherein a curvature radius R3 of an object-side surface of the second lens and a curvature radius R4 of the image-side surface of the second lens satisfy 0.2<R4/R3<0.8.

21. (canceled)

22. (canceled)

23. (canceled)

24. (canceled)

25. (canceled)

26. (canceled)

27. (canceled)

28. (canceled)
